(19) United States
(12) Patent Application Publication
(10) Pub. No.: US 2026/0288558 A1
(43) Pub. Date: Sep. 24, 2026

(54) SYSTEM

(71) Applicant: SoftBank Group Corp., Tokyo (JP)

(72) Inventor: Hiroshi ONO, Tokyo (JP)

(73) Assignee: SoftBank Group Corp., Tokyo (JP)

(21) Appl. No.: 19/564,283

(22) Filed: Mar. 12, 2026

(30) Foreign Application Priority Data
Mar. 19, 2025 (JP) 2025-044955

(51) Int. Cl. G06F 11/07

(52) U.S. Cl. CPC G06F 11/0751; G06F 11/0709

(57) ABSTRACT

A system includes a processor that is configured to: generate anomaly information output from an information processing device that monitors an operational status, generate a prompt for instructing a generative AI model to analyze the anomaly information and to identify contents of an anomaly by using the generative AI model, and input the generated prompt into the generative AI model so that the generative AI model automatically proposes the contents of the anomaly and an appropriate solution.

### CROSS-REFERENCE TO RELATED APPLICATION

This application is based on and claims priority under 35 USC 119 from Japanese Patent Application No. 2025-044955 filed on Mar. 19, 2025, the disclosure of which is incorporated by reference herein.

### BACKGROUND

### Technical Field

The Present Disclosure Relates to a System.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional system monitoring and incident management techniques require a human operator to interpret raw anomaly information, determine the nature and cause of an anomaly, and select an appropriate solution. In many environments, an information processing device, such as a server or management console, outputs various logs and anomaly information when an abnormal event occurs. However, the interpretation of this anomaly information is typically manual, time-consuming, and highly dependent on the skill and experience of a system administrator. As a result, there is a delay between the occurrence of an anomaly and the implementation of an appropriate countermeasure, which can increase system downtime and operational costs. Furthermore, even when machine learning or rule-based systems are used, such systems are often rigid and lack the ability to flexibly leverage accumulated historical anomaly data and corresponding solutions for new or complex incidents. Therefore, there is a need for a system that can automatically analyze anomaly information output from an information processing device, accurately identify the contents and causes of anomalies by effectively utilizing a generative AI model, and promptly propose appropriate solutions based on both current and past anomaly information and their resolutions.

### SUMMARY

In order to solve the above-described problems, a system is provided comprising a processor, wherein the processor is configured to generate anomaly information output from an information processing device that monitors an operational status, generate a prompt for instructing a generative AI model to analyze the anomaly information and to identify contents of an anomaly by using the generative AI model, and input the generated prompt into the generative AI model so that the generative AI model automatically proposes the contents of the anomaly and an appropriate solution. In addition, the processor is configured, on the basis of contents of the anomaly information, to generate a prompt for instructing the generative AI model to refer to past anomaly information and corresponding solutions and to identify a cause of the anomaly by using the generative AI model. Furthermore, the processor is configured, when proposing a solution to the anomaly, to generate a prompt for instructing the generative AI model to refer to past anomaly information and corresponding solutions and to select an optimal solution to the anomaly by using the generative AI model. By systematically generating such prompts and supplying them to the generative AI model, the system enables automatic and context-aware analysis of anomaly information, automatic identification of anomaly contents and causes, and automatic selection and proposal of appropriate and optimal solutions, thereby reducing the burden on human operators and shortening the time required to respond to anomalies.

The term “system” refers to an integrated combination of hardware and/or software components that cooperate to perform monitoring, analysis, and solution proposal processing as defined in the claims.

The term “processor” refers to one or more hardware processing units, such as a central processing unit (CPU), a graphics processing unit (GPU), a dedicated accelerator, or a combination thereof, which execute instructions to perform the functions specified in the claims.

The term “information processing device” refers to a device, such as a server, computer, or network appliance, that executes software or firmware to monitor an operational status of a system or component and outputs anomaly information based on detected abnormal events.

The term “operational status” refers to a state or condition of operation of hardware, software, or a combination thereof, including performance metrics, resource utilization, error states, transaction results, and other status indicators relevant to system health.

The term “anomaly information” refers to information indicating an abnormal event or state detected by the information processing device, including but not limited to error logs, alert messages, exception reports, failure codes, and associated contextual data.

The term “generative AI model” refers to an artificial intelligence model, such as a large language model or other generative model, that is capable of generating text or other output content in response to input data, including prompts, and that is used to analyze anomaly information, identify anomaly contents and causes, and propose solutions.

The term “prompt” refers to data, typically expressed in natural language or a structured instruction format, that is generated by the processor and provided as input to the generative AI model in order to instruct the generative AI model to perform a specific analysis or decision-making task.

The term “contents of an anomaly” refers to details that characterize an anomaly, including but not limited to the type of anomaly, affected components, time of occurrence, relevant parameters, and specific conditions under which the anomaly occurred.

The term “cause of the anomaly” refers to an underlying factor, condition, or combination of events that leads to the occurrence of the anomaly, such as configuration errors, software defects, hardware failures, or external influences.

The term “solution” refers to an action or set of actions, including operational procedures, configuration changes, software patches, or hardware replacements, that are intended to mitigate, correct, or prevent the anomaly.

The term “appropriate solution” refers to a solution that is suitable to address a specific anomaly in view of the anomaly's contents and operational context, and that is expected to resolve or mitigate the anomaly without causing unacceptable side effects.

The term “optimal solution” refers to a solution that is selected, among multiple candidate solutions, as being most suitable according to one or more criteria, such as effectiveness, speed of implementation, risk, resource consumption, or historical success rate.

The term “past anomaly information” refers to previously recorded anomaly information, including associated logs, alerts, and contextual data, that have been stored for later reference and analysis.

The term “corresponding solutions” refers to solutions that were previously applied or recorded in association with specific past anomaly information and that are available to be referenced by the generative AI model for comparison, reasoning, or reuse.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

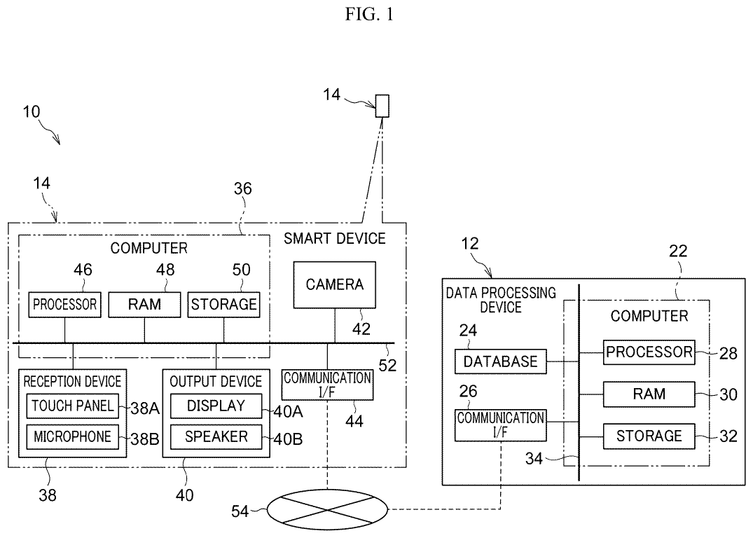

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

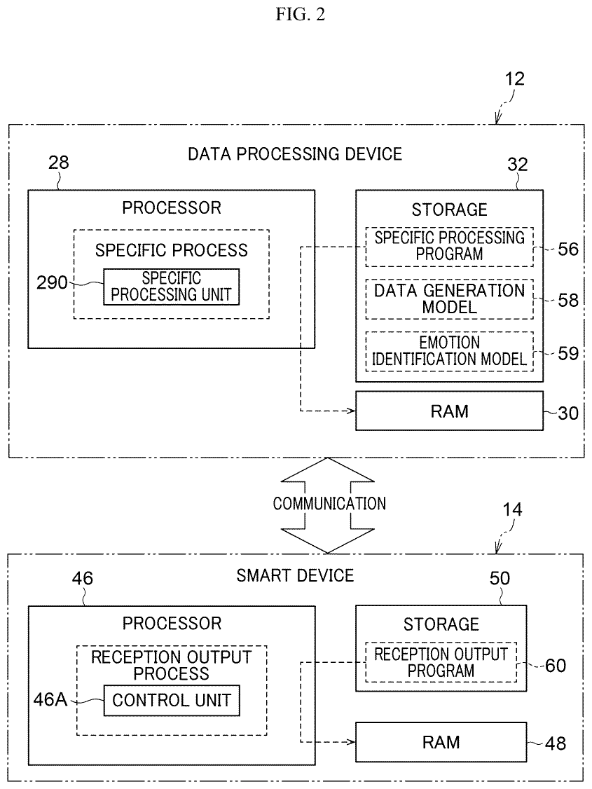

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional monitoring and incident-management systems for information processing environments typically separate metric collection, anomaly detection, root-cause analysis, and remediation planning into loosely coupled or manual stages. Monitoring components may raise alerts based on simple threshold rules, but human operators are generally required to read raw log files, correlate multiple error messages, consult external documentation, and manually draft remediation procedures. This fragmented workflow imposes substantial cognitive load on operators, increases mean time to detect (MTTD) and mean time to repair (MTTR), and scales poorly as system complexity and log volume increase.

In particular, even when a generative AI model or another language model is available, existing approaches usually rely on an operator to craft ad hoc prompt sentences, to decide which portions of anomaly information and environment context should be supplied to the model, and to interpret and operationalize the model's natural-language output. Such manual prompt engineering is inconsistent across operators, is difficult to standardize, and is not systematically linked to the underlying monitoring pipeline. As a result, the effectiveness and reproducibility of AI-assisted analysis and remediation are limited.

Furthermore, typical systems do not treat prompts, AI outputs, and anomaly metadata as first-class, machine-reusable artifacts. Past prompts and responses are rarely stored in structured association with specific anomaly instances, so the system cannot automatically reuse successful prompts or analysis results when similar anomalies recur. Existing architectures therefore underutilize historical AI interactions and fail to progressively automate incident handling based on accumulated experience.

From a computer-technology perspective, there is a need for a system-level mechanism in which a processor automatically (i) converts low-level monitoring signals into structured anomaly information, (ii) generates standardized prompt sentences that encode anomaly and environment context as machine-processable instructions to a generative AI model, (iii) integrates the model's natural-language analysis and countermeasures back into the system as structured artifacts suitable for storage, retrieval, and automation, and (iv) reuses stored prompts and AI analysis results to reduce computation and operator effort for subsequent, similar anomalies. Without such an integrated mechanism, computer systems cannot fully leverage generative AI models to improve the technical performance of anomaly management, including reduction of processing overhead for operators, faster and more consistent decision making, and systematic automation of remediation workflows.

The specific processing by the specific processing unit 290 of the data processing device 12 in Example 1 is realized by the following means.

The present invention provides a server comprising a processor configured to obtain monitoring information indicating an operating status of an information processing apparatus, perform threshold determination or pattern determination on the monitoring information to determine whether an anomaly is present, and, when the anomaly is detected, generate anomaly information including at least an error type, an occurrence time, and related data as structured data; to generate a prompt sentence including the generated anomaly information and environment information associated with the anomaly information, the prompt sentence being configured to instruct a generative language processing model to perform analysis of anomaly content, estimation of a cause, and presentation of a countermeasure, and to input the generated prompt sentence into the generative language processing model and acquire, from the generative language processing model, a natural language output including at least anomaly content, a cause, and a countermeasure; to store or present the natural language output in association with the anomaly information; to extract, from the natural language output, an operation procedure or a processing command and generate, on the basis of the operation procedure or the processing command, an automatic processing job or an operation procedure document; and to store, in associated form, the anomaly information, an analysis result obtained by the generative language processing model, and the generated prompt sentence and to, for a subsequently occurring anomaly, reuse at least one of the stored prompt sentence and the stored analysis result to automate or simplify generation of a new prompt sentence. This enables the server to technically improve computer-implemented incident handling by transforming raw monitoring data into standardized prompt sentences, by tightly integrating generative AI analysis into a structured anomaly-management pipeline, by generating machine-executable remediation artifacts from natural-language output, and by reusing stored prompts and analysis results to reduce operator workload, shorten anomaly-resolution latency, and enhance the consistency and scalability of anomaly detection, diagnosis, and remediation.

The term “monitoring information” refers to data indicating an operating status of an information processing apparatus, including at least numerical or categorical values representing resource usage, performance metrics, or error conditions observed over time.

The term “operating status” refers to a state of execution or performance of an information processing apparatus, including at least processor utilization, memory utilization, storage access behavior, communication traffic, and application-level error occurrences.

The term “information processing apparatus” refers to any apparatus that executes computation or data processing, including at least a physical or virtual server, a computing node, a storage apparatus, or an application execution environment.

The term “threshold determination” refers to a process in which a measured value contained in monitoring information is compared with a predefined or dynamically learned reference value to determine whether the measured value exceeds, falls below, or otherwise deviates from a normal range.

The term “pattern determination” refers to a process in which a temporal or structural pattern in monitoring information is evaluated according to a predefined rule, a learned model, or a statistical criterion to determine whether the pattern indicates an anomaly.

The term “anomaly” refers to a deviation of the operating status of an information processing apparatus from an expected or normal condition, including at least performance degradation, functional failure, or data inconsistency.

The term “anomaly information” refers to structured or semi-structured data describing an anomaly, including at least an error type, an occurrence time, and related data indicative of a context in which the anomaly occurred.

The term “error type” refers to a classification label representing a category of anomaly, including at least types such as resource exhaustion, communication failure, data inconsistency, access permission error, or configuration error.

The term “occurrence time” refers to temporal information indicating when an anomaly was detected or determined to have occurred, including at least a timestamp expressed in a standardized time representation.

The term “related data” refers to contextual information associated with an anomaly, including at least identifiers of an information processing apparatus, a processing component, a data object, or a transaction related to the anomaly.

The term “structured data” refers to data organized according to a predefined schema or format, including at least key-value pairs, records, or objects suitable for machine parsing, storage, and retrieval.

The term “environment information” refers to information describing a hardware or software environment in which an anomaly occurs, including at least an operating system, a middleware component, an application framework, a configuration parameter, or a deployment topology.

The term “prompt sentence” refers to a sequence of tokens or characters constituting an input message that instructs a generative language processing model to perform a specific processing operation, including at least analysis of anomaly content, estimation of a cause, or presentation of a countermeasure.

The term “generative language processing model” refers to a machine-implemented model that receives a prompt sentence and generates natural-language output, the model including at least a probabilistic or neural network-based model configured to produce text by predicting token sequences.

The term “analysis of anomaly content” refers to a process in which a generative language processing model interprets anomaly information to produce a description, classification, or explanation of an anomaly.

The term “estimation of a cause” refers to a process in which a generative language processing model infers one or more likely root causes or contributing factors of an anomaly based on anomaly information and, optionally, historical data.

The term “countermeasure” refers to an action or procedure that is configured to reduce, mitigate, or eliminate an effect of an anomaly, including at least configuration changes, command executions, or maintenance operations.

The term “natural language output” refers to text generated by a generative language processing model in a human-readable language, the text including at least descriptive information, explanations, and procedural instructions.

The term “operation procedure” refers to a sequence of steps or instructions describing how to perform one or more operations on an information processing apparatus to address an anomaly.

The term “processing command” refers to a machine-interpretable instruction, including at least a command line instruction, a script fragment, or a database query, that can be executed by an information processing apparatus.

The term “automatic processing job” refers to a machine-executable workflow comprising one or more processing commands or tasks that are scheduled or triggered to execute without manual input.

The term “operation procedure document” refers to a record that describes an operation procedure in a structured textual format suitable for presentation to a user or conversion into an automatic processing job.

The term “knowledge base” refers to a data store that maintains structured representations of past anomalies, analysis results, and countermeasures, the data store being accessible for retrieval or reasoning during processing.

The term “similar-incident retrieval mechanism” refers to a processing component configured to retrieve, from a knowledge base, one or more past anomalies that are similar to a current anomaly according to a similarity metric.

The term “analysis result” refers to information generated by a generative language processing model in response to a prompt sentence, the information including at least an estimated cause of an anomaly and one or more countermeasures.

The term “reuse” refers to a process in which a previously stored prompt sentence or analysis result is used again, in unchanged or modified form, as part of processing for a subsequently occurring anomaly.

The term “subsequently occurring anomaly” refers to an anomaly that is detected after at least one earlier anomaly for which anomaly information, a prompt sentence, or an analysis result has already been stored.

In one embodiment, a server implements the claimed system as a network-connected computer including at least one processor, a main memory, a non-volatile storage device, and a communication interface. The server executes an operating system such as a general-purpose server operating system and runs a monitoring application, an anomaly management application, and an AI interface application. The server is connected via a communication network to one or more information processing apparatuses and to one or more terminals operated by a user.

The server uses software components such as a monitoring framework (for example, an agent-based monitoring tool), a relational database management system, a log collection framework, and a web application framework. The server further uses a machine learning framework, such as a neural network framework, to execute a generative AI model implemented as a transformer-type neural network. In another embodiment, the server does not locally host the generative AI model but accesses a remote generative AI service via an application programming interface.

The server acquires monitoring information from each information processing apparatus by causing a monitoring agent or monitoring plugin to run on or in association with the information processing apparatus. The monitoring agent reads low-level operating system counters (for example, processor time, memory page usage, storage read and write counts, and network packet statistics) and application-level indicators (for example, error counters and latency histograms). The server receives these values as structured records through a communication protocol and stores the records in a time-series data structure in the database. Each record includes, for example, a timestamp field, a device identifier field, a metric name field, and a metric value field.

The server executes a threshold determination and pattern determination on the stored monitoring information. The server applies, for example, vectorized arithmetic operations to sequences of metric values to calculate moving averages, moving standard deviations, and rate-of-change values within a recent time window. The server compares these processed values to threshold values stored in a configuration table. The configuration table includes, for each metric, a normal range, a critical threshold, and optionally a dynamic adjustment coefficient. The server also applies pattern determination by executing a time-series anomaly detection algorithm, such as a statistical anomaly detector or a small neural network that has been trained on historical normal behavior. The server thus determines, by explicit numerical comparison and pattern scoring, whether an observed operating status deviates from expected ranges.

When the server determines that an anomaly is present, the server constructs anomaly information as structured data. The server aggregates monitoring records, log entries, and configuration data into an anomaly object in memory. The anomaly object contains fields such as an error type field derived by rule-based classification of error messages, an occurrence time field derived from the earliest or most representative timestamp, and related data fields including identifiers of affected processes, storage volumes, database tables, and records. The server stores the anomaly object in an anomaly table in the database, with an anomaly identifier serving as a primary key. By converting a dispersed set of low-level metrics and logs into a unified anomaly object, the server reduces the number of database queries and joins required for subsequent processing and improves cache locality when accessing anomaly-related data.

The server further stores environment information associated with each anomaly. The environment information includes, for example, operating system version, application framework version, deployment topology, and critical configuration parameters at the time of anomaly occurrence. The server maintains this environment information in a normalized table and links it to each anomaly object by foreign keys. This structured association allows the server to later generate prompt sentences that accurately describe both the anomaly and its environment without repeatedly traversing raw configuration files.

The server generates a prompt sentence for a generative AI model by concatenating selected fields from the anomaly object and the environment information in accordance with a prompt template stored in memory. The prompt template is a textual pattern that specifies sections such as “Anomaly information:”, “Environment:”, and “Requested output:”. The server replaces placeholders in the template with encoded values from the anomaly object. For example, the server generates a prompt sentence such as:

“Analyze the following anomaly and propose detailed countermeasures.

Anomaly information: error_type: data inconsistency, occurrence_time: 2023, Oct. 5 14:35:22, host: db01, database: main_db, table: user_data, record_id: 12345.

Environment: database engine version 13, operating system version 20.04, replication enabled.

Provide safe, step-by-step remediation procedures and any precautions.”

The server applies deterministic formatting rules to avoid ambiguity and to ensure that similar anomalies produce structurally similar prompt sentences. This standardization improves token reuse and reduces the effective input complexity for the generative AI model, leading to faster and more stable inference. The server transmits the generated prompt sentence to the generative AI model by encoding the prompt into a sequence of tokens using a tokenizer associated with the model.

In one embodiment, the generative AI model is a transformer-based neural network including an embedding layer, multiple self-attention layers, feed-forward layers, layer normalization layers, and a final output projection layer. The model has been trained on a corpus that includes technical documentation, system logs, and maintenance procedures. During training, the server (or another training apparatus) used a supervised learning method, minimizing a loss function such as a cross-entropy loss over token sequences. The server updated model weights by applying a gradient-based optimization algorithm, such as stochastic gradient descent with momentum or adaptive methods, using mini-batch processing on a graphics processing unit or another parallel processing device. The training procedure optionally used data augmentation techniques, such as paraphrasing of technical descriptions and insertion of synthetic anomalies, to increase the model's robustness to variation in log formats and to improve generalization.

At inference time, the server feeds the tokenized prompt sentence to the generative AI model and executes the transformer layers. Each self-attention layer computes attention scores using dot-product operations between query, key, and value representations derived from the input tokens, and each feed-forward layer applies non-linear activation functions such as rectified linear units to transform intermediate representations. The server configures the generative AI model to generate sequences with constraints such as maximum token length, temperature, and top-probability threshold. The server thus obtains natural language output from the generative AI model, where the output typically contains a description of the anomaly, an estimated cause, and one or more countermeasures aligned as numbered steps.

The server stores the natural language output as structured text associated with the corresponding anomaly object. The server optionally parses the natural language output by applying pattern recognition rules and shallow natural language processing to extract operation procedures and processing commands. For example, the server identifies lines that begin with certain characters or that match command patterns for a command-line interpreter or a database client. The server converts these extracted commands into entries in a job definition data structure, which specifies an execution order, preconditions, and rollback procedures. The server may then store this job definition in a job management table and associate it with the anomaly object.

In one embodiment, the server presents the anomaly, the generated analysis result, and the operation procedure to a terminal. The terminal runs a web browser or dedicated client software and receives a structured representation of the anomaly object and associated texts via a communication interface. The terminal renders individual sections, such as “Anomaly summary”, “Estimated cause”, and “Suggested procedure”, in separate panels. The terminal can provide an operation element that allows the user to confirm execution of an automatically prepared processing job. The user, upon reviewing the procedure, can cause the server to execute the job on the relevant information processing apparatus by interacting with the terminal interface.

The server further maintains a knowledge base that stores past anomaly objects, the corresponding prompt sentences, and the natural language outputs from the generative AI model. The server indexes these records using feature vectors representing the anomaly content. To construct the feature vectors, the server may use an embedding model, such as a smaller transformer or a dedicated embedding network, that maps anomaly descriptions and environment information into a vector space. The server then stores the vectors in a vector index structure optimized for similarity search, such as an approximate nearest neighbor index. When a new anomaly occurs, the server computes a feature vector for the new anomaly and performs a similarity search against the stored vectors. If the server finds one or more past anomalies with high similarity scores, the server retrieves the stored prompt sentence or analysis result for those anomalies.

The server can then reuse or adapt a retrieved prompt sentence to generate a new prompt sentence with reduced computational effort. For example, the server replaces only fields that differ between the past anomaly and the new anomaly, while maintaining the structure and phrasing that previously yielded a high-quality result. This reuse reduces the amount of token generation and reduces the need for the generative AI model to infer structure from scratch. The reuse also improves consistency of analysis across similar anomalies, thereby reducing variance in problem-solving quality. The server can also derive meta-parameters for the generative AI model, such as temperature or length constraints, based on the performance history of past prompt sentences stored in the knowledge base.

In another embodiment, the server hosts multiple generative AI models that differ in size or specialization. The server selects a particular model for each anomaly based on attributes of the anomaly object, such as complexity of the environment or criticality of the affected system. The server can use a rule-based model selection mechanism or a small classifier network that has been trained to predict which model yields the best trade-off between response time and accuracy. By adaptively selecting the model, the server reduces overall computational load and network traffic, thereby improving throughput and latency for large-scale deployments.

The server improves computer technology by reconfiguring how monitoring data, anomalies, and language models interact at the system level. Conventional systems leave prompt design, context selection, and interpretation of AI output largely to human operators as external, unstructured steps. In contrast, the server integrates these steps into a repeatable, machine-executable pipeline, in which monitoring information is transformed into structured anomaly data, then into standardized prompt sentences, and finally into machine-readable remediation artifacts. This pipeline reduces the need for manual correlation of logs and manual drafting of incident reports, which are traditionally error-prone and time-consuming, and replaces them with deterministic data transformations and learned mappings that can be executed at processor speed.

By automatically structuring anomaly information and environment information, the server reduces the token count and redundancy in prompts, which lowers the computational cost of transformer inference on hardware accelerators. By reusing successful prompt sentences and analysis results, the server decreases the number of times that the generative AI model must perform long-context reasoning from scratch, thereby reducing inference latency and improving throughput under high alert loads. By generating automatic processing jobs and operation procedure documents directly from the natural language output, the server closes the loop between analysis and machine-executable remediation, which in turn reduces mean time to resolution and lowers the probability of human error when executing complex sequences of commands.

Moreover, the server's use of similarity-based retrieval and structured association of anomalies, prompts, and outputs results in improved precision and stability of cause estimation. The feature-vector indexing allows the server to use high-dimensional similarity metrics that are not easily applied by human operators. In doing so, the server can select more relevant past cases and can bias the generative AI model toward proven solutions. This approach reduces misdiagnoses and inconsistent remediation plans compared with purely manual or rule-based systems. The technical effect is not limited to business workflow efficiency; the system specifically improves the internal operation of computers and networks by optimizing data structures, heavy computation patterns, and model invocation sequences.

In yet another embodiment, the server employs alternative model architectures or training methods while preserving the same overall data flow. For example, the server may use an encoder-decoder architecture, a mixture-of-experts model, or a recurrent neural network with attention for the generative AI model. The server may use different loss functions (such as sequence-level losses or reinforcement learning from feedback) and different regularization methods (such as dropout or weight decay) during training. The server may also vary the message structure in the prompt sentence or use multi-part prompts that include both system-level instructions and user-level instructions. These variations allow adaptation to different deployment constraints, such as limited computational resources, strict latency requirements, or domain-specific vocabulary, while still providing the described technical improvements in anomaly handling.

The terminal and the user can participate in various ways in other embodiments. For example, the terminal can display a candidate prompt sentence generated by the server and allow the user to edit or approve it before sending it to the generative AI model. The user can supply additional domain constraints or safety policies, which the server incorporates into the prompt template. Feedback from the user, such as marking a particular AI-suggested procedure as “effective” or “ineffective,” can be recorded and used by the server to adjust similarity thresholds or prompt templates. Over time, this feedback loop leads to continuous refinement of the prompt generation and analysis process, with the server updating stored templates and model usage patterns to achieve further reductions in processing time and error rates.

Through these embodiments and variations, the server, terminal, and user cooperate to implement the claimed system in a manner that yields concrete technical improvements in the performance, reliability, and efficiency of computer-implemented anomaly management, while enabling other skilled persons to implement the invention by configuring standard hardware and software components as described.

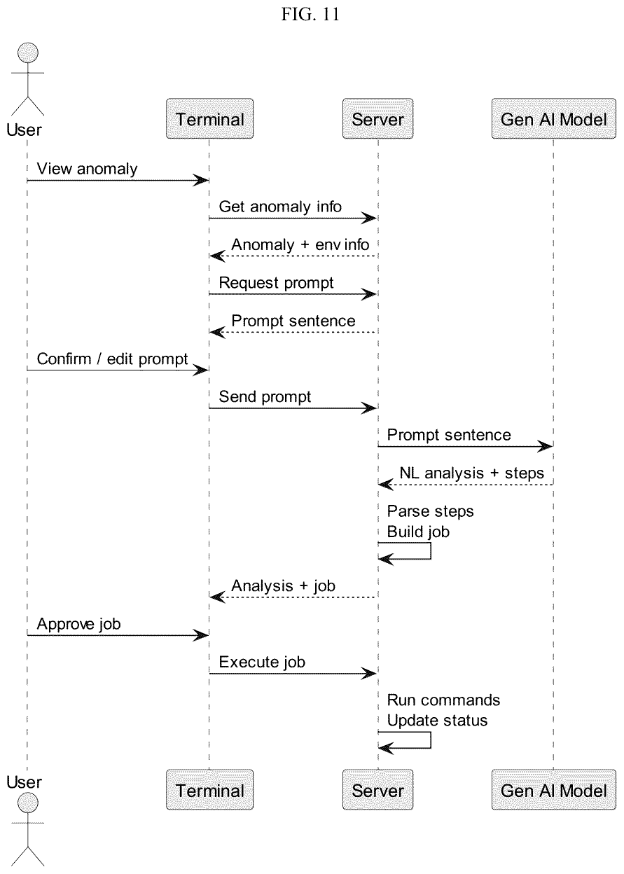

The following describes the processing flow using FIG. 11.

### Step 1

Server acquires monitoring information from each information processing apparatus.

Server receives, as input, metric values such as CPU usage, memory usage, disk I/O counts, and network traffic volumes, which are periodically sent by monitoring agents running on the information processing apparatuses.

Server parses the incoming data packets, extracts fields such as timestamp, host identifier, metric name, and metric value, and stores these fields as records in a time-series table in a database.

Server performs basic data normalization by converting raw counters into rates or percentages using arithmetic operations (subtraction, division, and scaling) based on previous records for the same metric.

Server outputs normalized monitoring records that are ready for anomaly detection processing.

### Step 2

Server determines whether an anomaly is present based on the monitoring information.

Server reads, as input, the normalized monitoring records produced in Step 1 and threshold values or pattern rules stored in a configuration table.

Server groups monitoring records by host and metric within a fixed time window, computes moving averages and standard deviations using numerical aggregation functions, and compares these computed statistics against configured thresholds.

Server also applies pattern detection algorithms, such as checking for sudden spikes or drops by calculating rate-of-change between consecutive samples and comparing the result to a defined pattern threshold.

Server outputs a set of anomaly flags and associated raw metric data for those metric streams and time windows that violate threshold or pattern rules.

### Step 3

Server generates structured anomaly information when an anomaly is detected.

Server receives, as input, anomaly flags and associated metric data from Step 2, as well as relevant log entries and configuration parameters retrieved from log storage and configuration repositories.

Server classifies each anomaly into an error type by applying rule-based pattern matching to error messages and metric combinations (for example, combining high CPU usage with specific error codes to infer a “data inconsistency” error type).

Server constructs an anomaly object containing fields such as anomaly identifier, error type, occurrence time, host identifier, affected component, and related data (for example, database name, table name, record identifier), and serializes this object into a structured format.

Server stores the anomaly object in an anomaly table and outputs a structured anomaly record that serves as the basis for prompt generation.

### Step 4

Server associates environment information with the anomaly.

Server takes, as input, the structured anomaly record from Step 3 and environment data stored in separate tables, such as operating system version, application version, deployment topology, and configuration values.

Server performs join operations using host identifiers, application identifiers, and timestamps to determine which environment parameters were active at the time of the anomaly.

Server merges the selected environment fields into a unified environment profile linked to the anomaly identifier.

Server outputs an augmented anomaly record that includes both anomaly information and associated environment information.

### Step 5

Server generates a prompt sentence for a generative AI model.

Server receives, as input, the augmented anomaly record from Step 4 and a prompt template stored in a template repository.

Server fills placeholders in the template with values from the anomaly record (such as error type, occurrence time, host, and related data) and from the environment profile (such as software versions and configuration states) by performing string substitution and formatting operations.

Server constructs a coherent natural-language prompt sentence, for example: “Analyze the following anomaly and propose detailed countermeasures.

Anomaly information: error_type: data inconsistency, occurrence_time: 2023 Oct. 15 14:35:22, host: db01, database: main_db, table: user_data, record_id: 12345.

Environment: database engine version 13, operating system version 20.04, replication enabled.

Provide safe, step-by-step remediation procedures and any precautions.”

Server outputs the prompt sentence as a text string ready to be sent to the generative AI model.

### Step 6

Server optionally reuses past prompts and analysis results to refine or shortcut prompt generation.

Server inputs the current augmented anomaly record and queries a knowledge base that stores past anomaly records, associated prompt sentences, and analysis results.

Server computes a feature vector for the current anomaly by encoding textual fields (error type, component names) using an embedding model and by concatenating numerical features (metric magnitudes, duration).

Server performs a similarity search over stored feature vectors using a distance metric to find past anomalies with high similarity, and retrieves their corresponding prompt sentences and outcomes.

Server adjusts the newly generated prompt sentence by reusing phrasing or structure from successful past prompts and may attach references to prior solutions, then outputs a final prompt sentence that incorporates historical knowledge.

### Step 7

Server sends the prompt sentence to the generative AI model and obtains a natural-language output.

Server takes, as input, the final prompt sentence from Step 5 or Step 6 and model parameters specifying maximum tokens and decoding strategy.

Server tokenizes the prompt sentence into a sequence of tokens using the tokenizer associated with the generative AI model, then invokes the model via an API call or local model interface.

Server causes the generative AI model to perform forward passes of the transformer layers, producing probability distributions over next tokens and iteratively generating a natural-language response.

Server decodes the generated token sequence into text, applies post-processing such as trimming, and outputs a natural-language result that includes an anomaly explanation, an estimated cause, and one or more recommended countermeasures.

### Step 8

Server structures and stores the generative AI model's output in association with the anomaly.

Server receives, as input, the natural-language result from Step 7 and the anomaly identifier from Step 3.

Server segments the text into logical sections (such as “Summary”, “Cause”, and “Steps”) using keyword detection and simple text parsing rules, and assigns each section to corresponding fields in an analysis result record.

Server inserts the analysis result record into an analysis table and creates links between the anomaly identifier, the prompt sentence, and the analysis result for later retrieval and reuse.

Server outputs an enriched anomaly entry that now includes machine-readable analysis and countermeasure information.

### Step 9

Server extracts operation procedures and processing commands from the natural-language output.

Server reads, as input, the analysis result record from Step 8, focusing on the section that describes remediation steps.

Server scans each line of the remediation text and applies pattern matching rules to detect commands (for example, detecting shell commands or database queries based on syntax) and structured steps (for example, lines starting with numbered prefixes).

Server builds an operation procedure structure that lists steps in order, annotates each step with step type (manual check, command execution, verification), and extracts machine-executable commands into a command list.

Server outputs an operation procedure object and a corresponding command list that can be used for automation.

### Step 10

Server generates an automatic processing job or an operation procedure document.

Server uses, as input, the operation procedure object and command list from Step 9.

Server maps each command and step into a job definition format required by a job scheduler or automation framework, adding metadata such as execution conditions, timeout values, and rollback actions.

Server serializes the job definition into a machine-readable representation and stores it in a job management repository, and also generates a human-readable operation procedure document by formatting the steps with headings and descriptions.

Server outputs both a job definition that can be executed automatically and a procedure document that can be displayed to a user.

### Step 11

Terminal presents anomaly information, analysis results, and proposed procedures to the user.

Terminal takes, as input, the enriched anomaly entry, analysis result, and operation procedure document received from the server over a network connection.

Terminal renders fields such as error type, occurrence time, estimated cause, and recommended steps in a graphical user interface, and highlights commands or high-risk operations.

Terminal allows the user to scroll, filter, and select specific anomalies and their associated procedures, and provides interactive controls for requesting job execution or for editing the suggested procedure.

Terminal outputs a visual display that enables the user to understand the anomaly and the system's proposed response.

### Step 12

User reviews and optionally modifies the proposed operation procedure.

User receives, as input, the rendered anomaly information and procedure displayed by the terminal.

User reads the explanation and recommended steps, and may add comments, disable certain steps, or adjust parameters such as target hosts or execution windows using input controls on the terminal.

User confirms or cancels execution of an associated automatic processing job by clicking buttons or issuing commands through the terminal interface.

User outputs a decision signal (approval, modification, or rejection) that the terminal forwards to the server.

### Step 13

Server executes or schedules the automatic processing job based on user input.

Server accepts, as input, the decision signal and, if approved, the job definition generated in Step 10.

Server submits the job definition to an execution engine or scheduler, which dispatches commands to the relevant information processing apparatuses via secure remote command channels or task agents.

Server monitors job status, collects execution logs, and updates the anomaly record with execution results, including success, failure, and any error messages.

Server outputs updated anomaly and job status information for subsequent display and for storage in the knowledge base to influence future prompt generation and analysis.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional monitoring and incident-management systems in computer environments generally rely on static rule sets or manually crafted scripts to detect anomalies, diagnose root causes, and determine remediation actions. Such systems often process event logs and metrics in a linear pipeline: logs are collected, threshold-based alarms are triggered, and human operators manually interpret error messages and compose recovery procedures. This architecture imposes several technical limitations.

First, conventional systems have limited ability to interpret heterogeneous and evolving log formats or complex multi-component failure modes. When log messages or system architectures change, rule sets and scripts must be manually updated, which leads to brittle behavior, delayed adaptation, and increased risk of false positives and false negatives in anomaly detection. Second, even if an anomaly is detected, conventional systems rarely integrate accumulated incident-response history in a structured way to infer probable causes or to synthesize optimized remediation sequences. As a result, similar failures are repeatedly analyzed from scratch, increasing mean time to detect (MTTD) and mean time to repair (MTTR).

Third, when generative AI models are naively integrated into such systems, they are typically used only as an auxiliary tool operated manually by an engineer, or they are invoked with ad hoc prompts that are not systematically derived from machine-readable abnormality records and historical incident data. In these approaches, the generative AI model operates on unstructured or partially structured inputs, which can yield inconsistent, non-reproducible, or incomplete remediation guidance. This undermines reliability and makes it difficult to integrate generative outputs into automated control flows that safely execute against managed computing resources.

Fourth, feedback from actual remediation executions, including success or failure outcomes and low-level control logs, is rarely captured as structured data and reused as training or conditioning data for subsequent detection, diagnosis, and remediation cycles. Without such a closed feedback loop, the system cannot effectively learn from prior responses to improve the precision of cause classification, the prioritization of actions, or the quality of the prompts sent to a generative AI model.

Accordingly, there is a need for a technical framework that tightly integrates (i) structured acquisition of operation history and abnormality record data, (ii) machine learning-based root-cause analysis and importance evaluation, (iii) systematic generation of prompt sentences tailored for a generative AI model, (iv) automatic synthesis of concrete, executable control procedures from generative outputs, and (v) persistent accumulation of abnormality-response history as reusable learning data. Such a framework should improve the functioning of computer systems themselves by reducing processing latency, increasing detection and diagnosis accuracy, enabling safer automation of control operations, and continually refining both analytical models and prompt-generation logic based on actual operational outcomes.

The specific processing by the specific processing unit 290 of the data processing device 12 in Application Example 1 is realized by the following means.

The present invention provides a server comprising a processor configured to acquire operation history information from an information processing apparatus, convert the operation history information into structured abnormality information data, determine based on the abnormality information data whether an abnormality has occurred, generate abnormality record data upon detection of the abnormality, generate analysis data including an abnormality cause candidate and an abnormality countermeasure candidate based on the abnormality record data and past abnormality record data, generate a prompt sentence including the analysis data, input the prompt sentence into a generative information processing model to obtain text data including abnormality content and recommended response procedures, generate notification data based on the text data and the abnormality record data and transmit the notification data to a communication apparatus, generate processing request data for a managed apparatus based on the notification data or an operation instruction from a user, execute control processing on the managed apparatus in response to the processing request data, and store a result of the control processing together with the text data as abnormality response history data and record the abnormality response history data as learning data reusable for generation of subsequent analysis data and prompt sentences. This enables an improvement in the operation of computer-based monitoring and control systems by automatically transforming raw operation history into structured abnormality representations, by using machine learning models and generative AI models in a coordinated manner to derive reproducible diagnoses and executable remediation procedures, and by closing a feedback loop in which outcomes of control actions are persistently learned, thereby reducing resource consumption, shortening detection and recovery times, and increasing reliability and adaptability of anomaly handling in complex computing environments.

The term “information processing apparatus” refers to an electronic apparatus that executes programs to process, store, or communicate data, including for example a server apparatus, a client apparatus, or a virtual computing instance.

The term “operation history information” refers to data representing time-series behavior of an information processing apparatus, including log messages, status codes, performance metrics, event records, and other runtime observations output by hardware or software components.

The term “abnormality information data” refers to structured data obtained by analyzing operation history information to extract events, parameters, or patterns indicative of deviation from expected behavior of an information processing apparatus.

The term “abnormality record data” refers to data that describes a detected abnormal event in a consolidated form, including at least an abnormality type, a time of occurrence, related components, and associated operation history information.

The term “past abnormality record data” refers to abnormality record data stored from previous occurrences of abnormalities and maintained for later reference, comparison, or analysis.

The term “analysis data” refers to data that is generated by processing abnormality record data and past abnormality record data, and that includes at least one candidate cause of an abnormality and at least one candidate countermeasure for the abnormality.

The term “prompt sentence” refers to a machine-readable text or token sequence that encodes instructions, constraints, and contextual information, including analysis data, to be input to a generative information processing model.

The term “generative information processing model” refers to a trained information processing model that, in response to an input such as a prompt sentence, generates output data including natural-language text or structured data representing inferences, explanations, or action procedures.

The term “text data” refers to character-string data output by the generative information processing model, including at least a description of abnormality content and recommended response procedures.

The term “notification data” refers to data constructed for transmission to a communication apparatus, including information that identifies an abnormality, indicates its importance, and summarizes recommended or required actions.

The term “communication apparatus” refers to an electronic apparatus capable of sending or receiving digital information via a communication network, including for example a mobile terminal, a tablet terminal, or a general-purpose client terminal.

The term “managed apparatus” refers to an information processing resource that is a target of control by the server, including for example a computing apparatus, a storage apparatus, a network apparatus, or a virtual resource instance.

The term “processing request data” refers to data indicating a control operation to be performed on a managed apparatus, including identification of the target resource, specification of an operation type, and necessary parameters for execution.

The term “control processing” refers to processing that changes or verifies the state of a managed apparatus according to processing request data, including starting, stopping, configuring, or checking software or hardware components.

The term “abnormality response history data” refers to data representing past responses to abnormalities, including the content of control processing performed, results of the control processing, and associated text data obtained from the generative information processing model.

The term “learning data” refers to data used to train or adapt one or more models or algorithms, including machine learning models or prompt-generation logic, and in this context includes at least abnormality response history data reused for subsequent generation of analysis data and prompt sentences.

The term “machine learning model” refers to an information processing model configured by a training process using example data, and adapted to compute at least cause classification information or importance information of an abnormality based on input feature quantities.

The term “cause classification information” refers to data indicating a classification category or probability distribution over categories that represent possible causes of an abnormality, as computed by a machine learning model.

The term “importance information” refers to data indicating a degree of importance or severity of an abnormality, including for example priority levels, impact estimates, or risk scores derived from analysis data.

The term “feature quantities” refers to numeric or symbolic values extracted from abnormality record data or abnormality response history data, which quantitatively or qualitatively describe properties of events, components, or system states for input to a model.

The term “countermeasure candidate procedure” refers to a sequence of operations, commands, or configuration changes that is considered as a possible response to an abnormality, prior to selection based on an evaluation index.

The term “evaluation index” refers to one or more criteria used to compare or rank countermeasure candidate procedures, including for example expected success probability, execution time, resource cost, safety constraints, or historical performance.

The term “concrete processing procedures” refers to detailed, executable steps, including specific commands, parameter values, and execution order, that enable automatic execution of control processing on a managed apparatus.

In one embodiment, a server includes at least one processor, a main memory, a non-volatile storage device, and a network interface. The server executes an operating system such as a generic server operating system and one or more application programs implementing log collection, anomaly detection, analysis, prompt generation, interaction with a generative AI model, and control of external managed apparatuses. The server stores executable modules and configuration data in the non-volatile storage device and loads them into the main memory for execution by the processor.

The server acquires operation history information from one or more information processing apparatuses. The server uses concrete software components such as a log collector (for example, an agent similar to a file-based log shipper), a system log interface (for example, a journaling interface on an operating system), or an event tracing API on a general-purpose platform. The server reads log entries, performance metrics, and event traces over a network via the network interface or locally from files provided by the operating system. The server parses each record to extract standardized fields such as timestamps, component identifiers, severity levels, error codes, and message bodies. The server converts the parsed data into structured abnormality information data, for example, as records stored in a time-series database or a search engine similar to a distributed search and analytics engine.

The server applies a feature-extraction process to the abnormality information data. The server aggregates values over time windows, such as counts of specific error codes, average response times, memory consumption statistics, and network error ratios. The server encodes categorical attributes, such as service names or error categories, using techniques such as one-hot encoding or embedding indices. The server normalizes numerical attributes using pre-computed means and standard deviations stored in configuration data. The server stores the resulting feature vectors in a data structure such as a matrix or tensor maintained in main memory.

The server determines whether an abnormality has occurred by applying an anomaly detection model to the feature vectors. In one embodiment, the server executes a machine learning model implemented using a library such as a generic numerical computation framework. The server may use an Isolation Forest algorithm, in which the server represents each feature vector as a point in a multi-dimensional space and constructs a set of random decision trees. The server computes an anomaly score based on the average path length of the feature vector in the trees. The server compares the anomaly score to a configurable threshold and determines that an abnormality has occurred when the score exceeds the threshold. In another embodiment, the server uses an autoencoder neural network, which the server trains on normal operation data so that reconstruction error is low for normal patterns and high for abnormal patterns. The server calculates reconstruction error as a sum of squared differences between input and reconstructed feature vectors. The server compares this error to a threshold to detect anomalies.

When the server determines that an abnormality has occurred, the server generates abnormality record data. The server constructs a record that includes an abnormality type (for example, “database inconsistency,” “network latency,” or “resource exhaustion”), a time stamp, identifiers of affected components, and references to relevant operation history entries. The server stores this abnormality record in a relational database table along with a unique incident identifier. The server may also store a snapshot of relevant configuration parameters and environment status (for example, number of active processes, current resource allocation, or version identifiers of deployed software).

The server performs root-cause analysis and importance evaluation by applying a machine learning model to the abnormality record data and abnormality response history data. In one embodiment, the server uses a multi-layer neural network implemented with a general deep learning framework. The server defines an input layer that receives feature quantities derived from an abnormality record, such as encoded error types, counts of co-occurring events, time since last maintenance, and resource utilization statistics. The server defines several hidden layers using rectified linear unit activation functions and a final output layer that produces a probability distribution over cause categories. The server trains this model in advance using supervised learning. During training, the server reads labeled abnormality records and corresponding cause labels from stored historical data. The server computes a cross-entropy loss between the predicted distribution and the true labels and updates the model weights using a stochastic gradient descent algorithm or a variant such as Adam. The server repeats this process over multiple epochs until the validation accuracy stabilizes and meets a target criterion.

To represent importance information, the server may use a regression head attached to an intermediate layer of the same neural network to output a severity score in a continuous scale. The server trains this head using a loss function such as mean squared error between predicted severity and target severity derived from historical impact metrics (for example, system downtime duration or number of affected client sessions). The server thereby obtains cause classification information and importance information for a new abnormality by executing a forward pass of the learned model with the current abnormality's feature quantities.

The server constructs analysis data that includes at least one cause candidate and at least one countermeasure candidate. The server obtains cause candidates from the cause classification information and selects one or more categories with probabilities above a threshold. The server retrieves abnormality response history data from a database that stores past incidents and their resolutions. The server performs similarity search between the current abnormality and past incidents by comparing feature vectors (for example, using cosine similarity or Euclidean distance). The server selects a subset of past incidents whose features are closest to those of the current abnormality. The server extracts countermeasure candidate procedures from the associated response histories, including sequences of commands, configuration changes, or resource adjustments that previously led to successful resolutions.

The server generates a prompt sentence to be input to a generative AI model. The server constructs the prompt sentence in a deterministic, rule-based manner, using templates stored in a prompt-generation module. For example, the server may generate a prompt sentence of the following form:

“Analyze the following abnormality and propose a precise technical explanation and a step-by-step remediation procedure suitable for automated execution.

Abnormality type: [TYPE]

Time of occurrence: [TIMESTAMP]

Affected components: [COMPONENT LIST]

Detected causes (with probabilities): [CAUSE1: P1, CAUSE2: P2, . . . ]

Severity score: [SEVERITY]

Recent operation history:

[LOG EXCERPTS]

Past similar incidents and their resolutions:

[SUMMARIZED PAST CASES]

Output:
1. Short summary (one paragraph).
2. Detailed root-cause analysis.
3. Ordered list of concrete remediation steps, including example commands and parameter values.”

The server may also use additional prompt sentence examples, such as:

“Given the abnormality described below, generate a concise incident report and an ordered list of executable steps that can be applied by a management system to mitigate or resolve the abnormality. Focus on minimizing service interruption and avoiding redundant operations.

[CURRENT ABNORMALITY RECORD]

[RELEVANT METRICS AND CONFIGURATION DATA]”

By generating the prompt sentence from structured analysis data, the server constrains the generative AI model to operate on a well-defined context, which improves the reproducibility and completeness of the resulting guidance.

The server interacts with a generative AI model that is implemented as a neural network trained for sequence-to-sequence text generation. In one embodiment, the generative AI model has a transformer architecture including an encoder-decoder or decoder-only stack of multiple self-attention layers. Each layer includes multi-head attention sublayers and feed-forward sublayers with non-linear activation functions. The model parameters are stored in a model repository and loaded into a dedicated inference engine, which may execute on the same server or on a separate computational resource accessible over a network. The server sends the prompt sentence to the generative AI model using an application programming interface over a communication protocol such as HTTPS. The generative AI model computes attention weights over the input tokens and generates output tokens sequentially according to a decoding strategy such as beam search or nucleus sampling. The server receives the generated text data, which comprises a human-readable summary of the abnormality, a root-cause explanation, and one or more remediation procedures expressed as ordered steps. The server does not rely solely on the generative output as-is. Instead, the server parses the generated text data using a post-processing module. The server identifies explicit command structures, resource identifiers, parameter values, and preconditions described in the generated text. The server maps these elements to a predefined schema of controllable operations for the managed apparatuses. The server filters out any steps that conflict with system safety policies or fall outside an allowed set of operations. This non-conventional integration of generative output with a structured control schema ensures that the system uses the generative AI model not as an unrestricted decision-maker, but as a dynamic pattern synthesizer constrained by machine-interpretable rules.

The server generates notification data containing a short representation of the abnormality and the recommended response. The server includes at least the incident identifier, abnormality type, severity level, and a condensed suggestion of the primary countermeasure. The server transmits this notification data to a terminal acting as a communication apparatus, for example, a smartphone, a tablet, or a workstation, using a push-notification service over a network. The terminal receives the notification through an operating system notification interface and displays a graphical alert to the user. The notification may include an interaction element that, when activated by the user, causes the terminal to request detailed incident information from the server.

The terminal and the user cooperate with the server to decide whether to perform automated control processing. The terminal sends an operation instruction or an approval command to the server through a secure application interface. The server validates the instruction by checking user permissions and system safety constraints. If the server determines that the requested operation is permitted, the server generates processing request data for one or more managed apparatuses. The server translates the selected remediation procedure into concrete processing procedures, such as sequences of network messages, management protocol commands, or system-level commands. For example, the server may prepare commands to restart a service, reconfigure a database replication setting, or adjust a resource allocation in a virtualization platform. The server then executes these commands using orchestration tools or management APIs and monitors the results.

In one specific example, the server monitors a storage subsystem and detects a pattern of repeated integrity-check failures for a particular data volume. The server's anomaly detection model identifies this as an abnormality and the cause classification model outputs “replication inconsistency” as the most probable category. The server retrieves abnormality response history data showing that, in several previous incidents, a particular sequence of operations—temporarily suspending writes, performing a block-level resynchronization, and then running a consistency check—resolved the issue. The server constructs a prompt sentence embedding this analysis, sends it to the generative AI model, and receives a detailed explanation confirming the suspected cause and suggesting an optimized order of steps that reduces downtime. The server extracts a concrete set of commands from the generated output, maps them to the available management APIs, and presents an approval request to the user via the terminal. Upon approval, the server executes the steps and logs the outcome. The server records the success, the precise command sequence, and timing metrics as abnormality response history data, which is then used to refine thresholds and model parameters in subsequent training.

The server improves the functioning of the computer system itself in several ways. By employing learned anomaly detection models, the server reduces the number of false positives and false negatives relative to static threshold-based approaches, which reduces unnecessary alerts and missed failures. By generating structured prompts from machine-readable analysis data and reusing abnormality response history data, the server increases the technical precision of the generative AI model's outputs and enables consistent synthesis of executable procedures rather than generic text. The server's automatic mapping from generative output to constrained control operations reduces risk of unsafe actions and permits partial automation of complex remediation workflows while still allowing user oversight.

From a computational perspective, the server reduces the overall processing burden by applying feature extraction and dimensionality reduction before feeding data into complex models. For example, the server may apply principal component analysis or other transformations to reduce input dimensionality, thereby decreasing inference time and memory usage. The server may also cache intermediate feature representations for frequently occurring patterns, which reduces redundant computation. These optimizations provide tangible technical effects such as lower CPU utilization, reduced network traffic between data collection agents and the central analysis server, and shorter time to decision when an abnormality occurs.

The server employs non-conventional procedures compared with manual or rule-based workflows. Instead of a straightforward pipeline in which humans interpret logs and manually author scripts, the server automatically correlates heterogeneous data sources, constructs semantically rich analysis data, and then uses a generative AI model under strict prompting templates and post-processing constraints to synthesize procedures that are both context-aware and machine-executable. This approach does not merely automate human mental steps; rather, it leverages high-dimensional pattern recognition and probabilistic reasoning across large histories of incidents that are infeasible for humans to process in real time. The resulting system achieves improved accuracy in cause classification, reduces the number of redundant or ineffective remediation attempts, and enhances the efficiency of data management by continuously updating models and knowledge based on concrete operational results.

In alternative embodiments, the server may use different machine learning architectures for the analysis module, such as gradient-boosted decision trees or graph neural networks for representing dependencies among services. The server may apply different generative AI models, such as encoder-decoder architectures specialized for technical instructions, or may host multiple generative models and select among them based on incident type. The server may also operate in a distributed manner, where separate nodes handle log ingestion, model inference, and control execution, communicating via a message queue or service bus. In each variation, the server still generates structured abnormality record data, constructs analysis data including cause and countermeasure candidates, generates prompt sentences for a generative AI model, obtains detailed text data, and uses that text data together with abnormality response history data to carry out controlled operations on managed apparatuses and to refine future analyses and prompts.

The terminal may be implemented as a native application, a web application, or a hybrid application, as long as the terminal can receive notification data, display abnormality information, and send operation instructions to the server. The user may be an administrator, an operator, or an automated supervisory process that interacts with the terminal via an interface. Regardless of implementation details, the server remains the central component that coordinates acquisition of operation history information, AI-based analysis, interaction with a generative AI model, and concrete control of managed apparatuses, thereby embodying the claimed system and producing the technical effects described above.

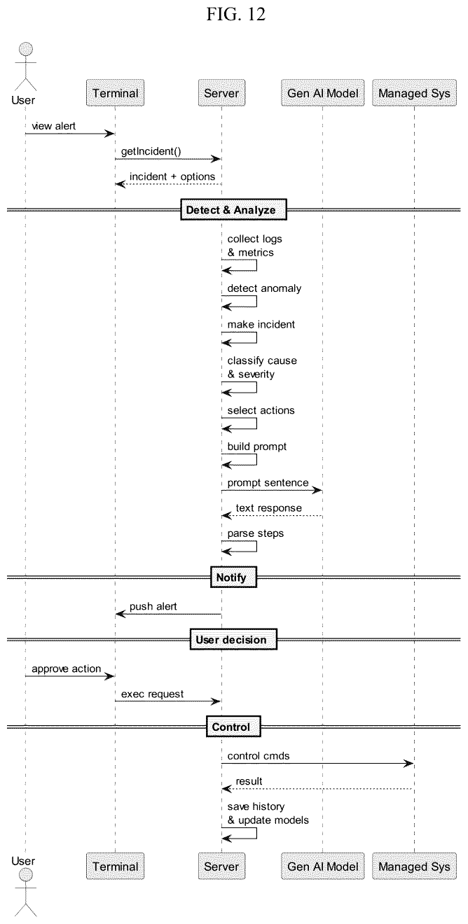

The following describes the processing flow using FIG. 12.

### Step 1

The server acquires operation history information from one or more information processing apparatuses.

The input in this step is raw runtime output such as log lines, event records, and performance metrics provided by operating systems and application programs. The server reads this input via log files, system APIs, or network messages. The server parses each record to extract fields including timestamps, component identifiers, severity levels, error codes, and message bodies. The server then normalizes date-time formats, converts numeric strings to numeric values, and maps component names to internal identifiers. The output of this step is structured abnormality information data, which the server stores in an internal data structure such as a table or a time-series record set.

### Step 2

The server generates feature quantities from the structured abnormality information data.

The input in this step is the structured abnormality information data generated in Step 1. The server groups records by time windows and components, and the server computes aggregations such as counts of specific error codes, moving averages of response times, maximum resource utilization values, and rates of warning and error events per window. The server applies encoding to categorical attributes (for example, error type or service name) and normalization to numeric attributes using stored scaling parameters. The server concatenates these processed values into feature vectors. The output of this step is a collection of feature vectors representing the recent operational state of the monitored apparatuses.

### Step 3

The server detects abnormalities using an anomaly detection model.

The input in this step is the collection of feature vectors from Step 2. The server passes each feature vector into an anomaly detection model, such as an Isolation Forest or an autoencoder neural network. The server executes the model to compute an anomaly score or reconstruction error for each feature vector. The server compares the computed value with a predefined threshold and classifies each feature vector as normal or abnormal. The output of this step is an abnormality detection result, including identification of feature vectors judged as abnormal and their associated scores.

### Step 4

The server generates abnormality record data when an abnormality is detected.

The input in this step is the abnormality detection result from Step 3 and the corresponding structured abnormality information data from Step 1. For each detected abnormality, the server collects related log entries, metrics, and component identifiers within a relevant time range. The server determines an abnormality type based on rule mapping or preliminary classification, assigns a unique incident identifier, and records the occurrence time and affected components. The server writes this information as abnormality record data into a persistent storage system such as a relational database. The output of this step is one or more abnormality record data entries ready for further analysis.

### Step 5

The server computes cause classification information and importance information for the abnormality.

The input in this step is the abnormality record data created in Step 4 and abnormality response history data stored from past incidents. The server transforms the abnormality record into feature quantities suitable for a cause-classification model, including encoded abnormality type, error code distributions, co-occurring event patterns, and resource utilization statistics. The server also retrieves similar past incidents and their features from the abnormality response history data. The server feeds the combined feature set into a trained machine learning model, such as a multi-layer neural network, and executes a forward pass to obtain a probability distribution over cause categories and a numerical severity score. The server interprets the highest-probability categories as cause candidates and the severity score as importance information. The output of this step is analysis data containing cause classification information and importance information for the current abnormality.

### Step 6

The server selects countermeasure candidate procedures based on analysis data and abnormality response history data.

The input in this step is the analysis data from Step 5 and the abnormality response history data stored in the server. The server searches for past incidents whose features are similar to the current abnormality by computing similarity measures (for example, cosine similarity) between feature vectors. The server retrieves resolution procedures associated with those incidents, including ordered lists of operations such as restarting services, reconfiguring parameters, or executing diagnostics. The server filters and ranks these procedures using the cause classification information and importance information, and the server extracts a subset as countermeasure candidate procedures. The output of this step is a set of countermeasure candidate procedures associated with the current abnormality.

### Step 7

The server generates a prompt sentence including analysis data and countermeasure candidate procedures.

The input in this step is the analysis data from Step 5 and the countermeasure candidate procedures from Step 6. The server loads a prompt template from a prompt-generation module and fills template slots with specific values such as abnormality type, time of occurrence, affected components, cause candidates and probabilities, severity score, recent log excerpts, and summarized past resolutions. The server concatenates these elements into a coherent natural-language prompt sentence. The server ensures that the prompt sentence specifies the required output format, such as a summary section and a numbered list of remediation steps. The output of this step is a complete prompt sentence configured for input to a generative AI model.

### Step 8

The server obtains text data from a generative AI model based on the prompt sentence.

The input in this step is the prompt sentence produced in Step 7. The server sends the prompt sentence to a generative AI model via a network interface, using an application programming interface that accepts text input and returns generated text output. The server triggers the generative AI model, which processes the prompt sentence and generates a response according to its internal transformer-based architecture. The server receives the generated text data, which typically includes a short summary of the abnormality, a detailed root-cause explanation, and a step-by-step remediation plan. The output of this step is the text data produced by the generative AI model.

### Step 9

The server parses the generated text data and constructs executable remediation candidates.

The input in this step is the text data obtained in Step 8. The server applies a text parsing algorithm to identify explicit operations, command patterns, parameter values, and dependencies described in the text. The server maps these elements to a predefined operation schema for the managed apparatuses, such as types of allowable control commands and required arguments. The server discards or marks as non-executable any operations not matching the schema or violating safety constraints. The server organizes the remaining operations into ordered remediation candidates that can be executed by the control subsystem. The output of this step is a set of structured remediation candidates derived from the generated text data.

### Step 10

The server creates notification data summarizing the abnormality and recommended actions.

The input in this step is the abnormality record data from Step 4, the analysis data from Step 5, and the structured remediation candidates from Step 9. The server composes a concise notification message including the incident identifier, abnormality type, severity level, and a brief description of the primary recommended action. The server may also include an indicator of whether automatic remediation candidates are available. The server formats this information into notification data suitable for a push notification service. The output of this step is notification data that can be transmitted to a terminal.

### Step 11

The terminal receives and displays the notification to the user.

The input in this step is the notification data transmitted by the server through a push-notification infrastructure. The terminal accepts the notification via the operating system's notification framework, decodes the payload, and renders a visible alert containing the abnormality summary and severity. The terminal provides an interactive element, such as a button, that allows the user to open a detailed incident view or to approve an automated action. The output of this step is a user-visible representation of the abnormality and the available response options.

### Step 12

The user reviews the abnormality details and selects a desired action.

The input in this step is the abnormality information and recommended actions displayed by the terminal. The user reads the summary, the severity indication, and any presented remediation options. The user may choose to request more details, to approve automatic remediation, or to defer action. The user interacts with the terminal's user interface, for example by tapping a button labeled with an action such as “View details” or “Execute recommended remediation.” The output of this step is an operation instruction generated by the user's selection, which the terminal sends to the server.

### Step 13

The server generates processing request data for a managed apparatus based on the user instruction and remediation candidates.

The input in this step is the operation instruction from Step 12 and the structured remediation candidates from Step 9. The server validates the instruction by checking user credentials and permission settings. The server chooses one remediation candidate procedure, for example the highest-ranked candidate according to an evaluation index such as expected success rate or minimal downtime. The server converts each step in the selected procedure into one or more low-level commands or API requests specific to the managed apparatus. The server bundles these commands into processing request data, including identifiers of target resources, operation types, and parameter values. The output of this step is fully specified processing request data ready for execution.

### Step 14

The server executes control processing on the managed apparatus using the processing request data.

The input in this step is the processing request data from Step 13. The server uses management interfaces such as remote command execution tools, device control APIs, or orchestration frameworks to send control commands to the managed apparatus. The server executes commands such as starting or stopping services, adjusting configuration parameters, initiating synchronization operations, or running diagnostic checks. The server monitors responses and status codes from the managed apparatus and logs any errors or confirmations. The output of this step is a control processing result that includes success or failure indicators, execution times, and any returned diagnostic information.

### Step 15:

The server generates and stores abnormality response history data based on the control processing result and the text data.

The input in this step is the control processing result from Step 14 and the text data obtained in Step 8. The server constructs abnormality response history data by combining the executed remediation sequence, the outcome status, timing metrics, and the explanatory content taken from the generated text data. The server associates this history data with the incident identifier and abnormality record data and saves it in persistent storage, such as a database table dedicated to incident histories. The server may also update model-training datasets and adjust thresholds or parameters for anomaly detection and cause classification based on the new outcome. The output of this step is updated abnormality response history data that is available for use in future analysis, similarity search, and prompt sentence generation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems that analyze abnormal information output from information processing apparatuses typically rely on static rule engines, manually crafted correlation rules, or fixed-format log parsers. Such systems suffer from several technical limitations in terms of computer technology.

First, conventional systems lack flexible and fine-grained abstraction of heterogeneous, unstructured log data. When log formats, component names, or error messages change, the rule sets and parsers must be manually updated, which causes processing delays, increases configuration errors, and reduces system availability. As a result, the utilization of computing resources is inefficient because a central processing unit repeatedly executes brittle parsing and rule-evaluation code that cannot adapt to new abnormal patterns.

Second, conventional systems are not designed to systematically encode and exploit historical abnormal information and corresponding solutions as machine-interpretable knowledge. Even if past incidents and countermeasures are stored, they are often kept as free-text documents or operator notes. Therefore, the system cannot automatically infer relations between current abnormal information and past incidents at the machine level, and cannot dynamically optimize the selection of countermeasures. This leads to longer mean time to detect and mean time to repair, and also prevents effective reuse of prior computational results.

Third, conventional systems do not effectively integrate generative artificial intelligence models into the core log-processing pipeline in a way that is tightly coupled with structured data extraction, prompt generation, and feedback of model output into machine-usable data structures. In many cases, a generative artificial intelligence model, if used at all, is only called ad hoc by a human operator, with unstructured prompts and unstructured responses. Because prompts are not systematically constructed from structured log data, and responses are not automatically parsed and stored as structured analysis results, the overall system cannot achieve stable, repeatable, and scalable analysis performance at the level of a computing infrastructure.

Fourth, due to the absence of an automated mechanism that transforms abnormal information and historical data into explicit prompt sentences with precise instructions to the generative artificial intelligence model, the quality and consistency of the model's inferences are highly dependent on the human operator's skill. This leads to non-deterministic behavior of the anomaly analysis workflow, reduced reliability of system outputs, and difficulties in verifying and validating the system as a computer-implemented technology.

Accordingly, there is a need for a computer-implemented technique that:
(1) automatically converts unstructured abnormal information into structured data suitable for machine processing;
(2) systematically generates prompt sentences in a natural language that instruct a generative artificial intelligence model to perform specific computational tasks, including identification of abnormal contents, causes, and impact ranges, and selection of countermeasures;
(3) automatically parses the output of the generative artificial intelligence model into structured analysis results associated with identification information; and
(4) utilizes these analysis results to drive an information terminal in real time, thereby improving the efficiency, robustness, and scalability of anomaly analysis in information processing systems.

The technical problem to be solved by the present invention is to improve computer technology related to abnormal information processing by providing a server-side architecture and processing sequence that tightly integrates structured log extraction, prompt generation, and generative artificial intelligence model inference, thereby enhancing the accuracy, speed, and automation level of anomaly detection, root-cause identification, and countermeasure proposal in a computing environment.

The specific processing by the specific processing unit 290 of the data processing device 12 in Example 2 is realized by the following means.

The present invention provides a server comprising a processor configured to monitor an operating state of an information processing apparatus, periodically read log data including abnormal information from a storage unit, and acquire the abnormal information output from the information processing apparatus, to convert the acquired abnormal information into an analyzable format by performing character string analysis on unstructured text data including the abnormal information, to extract time information, identification information, resource name information, and event content information from the unstructured text data, and to store extraction results as structured data in the storage unit, to generate, on the basis of the structured data, a prompt sentence in a natural language that instructs a generative artificial intelligence model to identify a content of an abnormality, a cause of the abnormality, and an impact range of the abnormality and to generate a countermeasure for the abnormality, and to generate input data for the generative artificial intelligence model including the prompt sentence, to cause the generative artificial intelligence model to operate on the input data including the structured data and the prompt sentence and to acquire output data including an analysis result relating to the content of the abnormality, the cause of the abnormality, the impact range of the abnormality, and the countermeasure, and to analyze the output data, extract information indicating the content of the abnormality, the cause of the abnormality, the impact range of the abnormality, and the countermeasure, associate the information with the identification information, store the associated information in the storage unit, and convert the information into display data to be notified to an information terminal, and further configured to transmit the display data to the information terminal via a communication network so that the information terminal displays the content of the abnormality, the cause of the abnormality, the impact range of the abnormality, and the countermeasure. This enables the server to implement, as a concrete improvement in computer technology, an automated and adaptive anomaly analysis pipeline in which unstructured abnormal information is deterministically transformed into structured data, used to construct precise prompt sentences for a generative artificial intelligence model, and fed back as structured analysis results that are immediately usable by other computer components, thereby improving processing efficiency, analysis accuracy, fault recovery speed, and overall robustness of information processing systems.

The term “system” refers to a combination of one or more hardware units and software units that cooperate to execute information processing, including at least one processor, at least one storage unit, and at least one communication interface.

The term “processor” refers to a hardware computation unit, such as a central processing unit or other arithmetic logic device, that executes machine-readable instructions to perform the functions described herein.

The term “information processing apparatus” refers to a device including at least one processor and at least one memory that executes a predetermined application or service and outputs log data including abnormal information during its operation.

The term “operating state” refers to a condition of execution of software or hardware resources in the information processing apparatus, including status of processes, services, data access, and error occurrences.

The term “log data” refers to data that records events occurring in the information processing apparatus, including normal events and abnormal events, in a time-sequenced manner.

The term “abnormal information” refers to information included in the log data that indicates an error, fault, malfunction, or other non-normal condition occurring in the information processing apparatus.

The term “storage unit” refers to a hardware storage device, such as a semiconductor memory, magnetic storage, or optical storage, that retains log data, structured data, and analysis results.

The term “unstructured text data” refers to character string data in which semantic elements such as time information, identification information, and event contents are not arranged according to a predefined schema or fixed field format.

The term “character string analysis” refers to a processing operation in which the processor examines text data using techniques such as pattern matching, regular expression matching, or tokenization to identify and extract specific elements.

The term “time information” refers to data indicating a time point or time period associated with the occurrence of an event, including timestamps or other temporal identifiers.

The term “identification information” refers to data used to uniquely or distinctively identify an entity, such as a log entry, resource, component, or abnormality, including identifiers like IDs, names, or codes.

The term “resource name information” refers to data indicating a name of a computational or storage resource, such as a component, service, database, or data structure, associated with an event.

The term “event content information” refers to data describing the substance of an event, including error messages, warning descriptions, and status descriptions.

The term “structured data” refers to data organized according to a predefined schema or data model, in which fields such as time information, identification information, resource name information, and event content information are explicitly defined.

The term “prompt sentence” refers to a sequence of words expressed in a natural language that instructs a generative artificial intelligence model to perform a specific analysis or generation task on provided input data.

The term “natural language” refers to a human language used for everyday communication, such as English or Japanese, that is interpretable by the generative artificial intelligence model.

The term “generative artificial intelligence model” refers to a trained computational model that receives input data including a prompt sentence and produces output data such as generated text or structured information based on learned patterns.

The term “input data” refers to data provided to the generative artificial intelligence model, including the prompt sentence and associated structured data derived from abnormal information.

The term “content of an abnormality” refers to information indicating what kind of abnormal condition has occurred, including type, location, and symptoms of the abnormal condition.

The term “cause of the abnormality” refers to information indicating a factor, condition, or event that leads to or triggers the abnormal condition.

The term “impact range of the abnormality” refers to information indicating a scope of influence of the abnormal condition, including affected resources, components, data sets, or users.

The term “countermeasure” refers to an operation, procedure, or configuration change recommended for mitigating, correcting, or preventing recurrence of the abnormal condition.

The term “output data” refers to data generated by the generative artificial intelligence model in response to the input data, including analysis results related to the content, cause, impact range, and countermeasure of an abnormality.

The term “analysis result” refers to information derived from processing by the generative artificial intelligence model that interprets abnormal information and provides conclusions or suggestions regarding the abnormality.

The term “display data” refers to data formatted for presentation on an information terminal, including textual or structured representations of the content of the abnormality, the cause of the abnormality, the impact range of the abnormality, and the countermeasure.

The term “information terminal” refers to a device operated by a user that receives display data via a communication network and presents the data to the user, such as a personal computer, smartphone, or tablet.

The term “communication network” refers to a wired or wireless network, including local networks and wide-area networks, through which the server and the information terminal exchange data.

The server according to one embodiment includes at least one processor, at least one memory, a storage device such as a semiconductor storage or magnetic disk, and a network interface. The server executes an operating system and one or more application programs implementing log acquisition, text analysis, data structuring, prompt sentence generation, generative AI model inference, and result distribution. The terminal includes a processor, a memory, a display device, an input device, and a communication interface, and executes a web browser or a dedicated application that communicates with the server. The user operates the terminal to inspect abnormal information and associated analysis results.

The server acquires log data generated by one or more information processing apparatuses such as application servers, database servers, or network devices. The information processing apparatus periodically or event-drivenly writes log entries, including abnormal information, to a log file stored on a local storage device or a shared storage device. The server accesses such log files via a local file system or a network file system. The server uses a log collection program, which may be implemented in a general-purpose programming language executed on the operating system, to open log files in read-only mode, track a read offset for each file, and read only newly appended log lines.

The server converts unstructured text data in the log lines into structured data suitable for machine processing. The server executes a text parsing module that uses pattern matching and regular expression matching implemented in a string processing library. The server applies multiple pattern templates to each log line to extract, for example, time information (timestamp), identification information (log identifier, device identifier, process identifier), resource name information (service name, database name, data structure name), and event content information (error message, warning description). The server stores extracted values in a data structure such as a record or an object with predetermined fields. The server aggregates such records into a table-like data structure held in memory and periodically stores the structured data in a database management system.

The server normalizes the structured data to reduce variance between heterogeneous log formats. The server converts timestamps to a unified time zone, standardizes resource name information according to a mapping table, and groups related abnormal entries into logical incident units based on temporal proximity and shared identification information. The server thereby creates incident-level structured data that more accurately represents abnormal phenomena at the system level, and reduces redundant or noisy information.

The server generates a prompt sentence in a natural language based on the structured data. The server composes the prompt sentence by concatenating template fragments and field values of the structured data in a predetermined order. The server includes in the prompt sentence explicit instructions to a generative AI model regarding the type of analysis to be performed and the desired output format. For example, when the structured data indicates that abnormal information is related to a table named “users” and includes a data inconsistency message, the server may generate a prompt sentence such as:

“Analyze the following abnormal log and identify the root cause, the impact range, and concrete recovery steps suitable for a system engineer.

Timestamp: 2026-01-30T01: 15:00Z

Component: database server

Database: main database

Table: users

Message: A data inconsistency occurred during access to the ‘users’ table.

Respond in JSON-like text with the items ‘cause’, ‘impact_range’, and ‘recommended_actions’ described in plain language.”

The server may generate another type of prompt sentence when referring to historical abnormal information, for example: “Based on the current abnormal log and the following summary of past similar incidents, identify the most likely cause and propose three prioritized countermeasures.

Current abnormal log:

Timestamp: 2026-01-30t01: 15:00Z

Component: database server

Table: users

Message: A data inconsistency occurred during access to the ‘users’ table.

Past incidents:
1) Data inconsistency in user-related tables caused by partial transaction rollback.
2) Index corruption on primary key columns in user tables.

Provide a concise explanation of the root cause and ranked countermeasures.”

The server inputs the prompt sentence, together with associated structured data, into a generative AI model. The generative AI model is implemented as a trained neural network, for example a transformer-based architecture including a token embedding layer, a plurality of self-attention layers, and a feedforward layer. The server tokenizes the prompt sentence using a tokenizer consistent with the training procedure of the neural network, converts tokens into integer indices, and then into vector embeddings. The server supplies such embeddings as input to the neural network, which executes on hardware such as a central processing unit alone or in combination with an accelerator such as a graphics processing unit.

The server uses a trained generative AI model whose parameters (weights and biases) have been obtained in advance by supervised learning. In training, the server or another training environment prepares training data consisting of input texts (logs and instructions) and target outputs (annotations including cause, impact range, and countermeasure descriptions). The server uses an objective function such as cross-entropy loss between predicted token distributions and ground-truth tokens. The server updates the model parameters by gradient-based optimization such as stochastic gradient descent or an adaptive method. The server may apply data augmentation methods, such as synonym replacement or template-based paraphrasing of log messages, to increase the robustness of the model to variations in expression.

The server in operation performs only inference, not training, for the generative AI model.

The server invokes an inference engine, which may be implemented as a dedicated service or library, to feed the tokenized prompt sentence into the neural network, compute attention scores between tokens, propagate activations through the layers, and generate a sequence of output tokens representing the model's analysis. The server applies decoding algorithms such as greedy decoding or beam search under constraints defined by the desired output structure. By requiring the model to output key items such as “cause”, “impact_range”, and “recommended_actions”, the server constrains the output token space and improves the determinism and reliability of the analysis result.

The server parses the generated text output into structured analysis results. The server uses parsing logic configured to detect delimiters, labels, or pre-defined markers in the output text produced by the generative AI model. The server associates extracted fields with corresponding incident identification information and stores them as structured analysis data.

The server may enrich the analysis data with additional computed metrics, for example a severity score derived from terms included in the “impact_range” or a confidence estimate computed by evaluating the consistency between the analysis result and known historical patterns.

The server then generates display data suitable for transmission to and rendering on the terminal. The server formats the content of the abnormality, the cause of the abnormality, the impact range of the abnormality, and the countermeasure in a form consumable by a user interface, for example a hierarchy of elements representing incident overview, detailed cause description, affected components, and step-by-step remediation instructions. The server sends such display data through a communication network by establishing a communication session with the terminal using a protocol such as Hypertext Transfer Protocol over Transport Layer Security.

The terminal receives the display data from the server and presents it on a display device. The terminal executes a rendering engine that interprets the display data, constructs a view with textual fields and graphical indicators, and allows the user to scroll, filter, or sort incidents. The terminal may additionally provide interactive controls for the user to request more detailed analysis or provide feedback on relevance of the proposed countermeasure. The terminal transmits such user requests back to the server, which can, in response, generate further prompt sentences incorporating user feedback and execute additional inference using the generative AI model.

The user inspects the information displayed on the terminal to understand the abnormality. The user can, for example, refer to the impact range description to determine whether to isolate a specific component or to switch traffic to a redundant system. The user can follow the recommended actions in the order presented, such as executing a data consistency check command, performing a backup verification, or applying configuration modifications suggested by the analysis result. The user may also compare multiple incidents through the terminal's interface to evaluate trends in system reliability.

The server improves computer technology in several ways. The server reduces computational cost associated with static rule engines by converting unstructured abnormal information into structured data suitable for learning-based processing and by delegating complex pattern recognition tasks to the generative AI model. The server optimizes memory access patterns by storing normalized structured data in contiguous data structures and performing vectorized operations during preprocessing. The server improves analysis accuracy and reduces false positives by using rich contextual features derived from structured data, such as temporal correlation and resource name normalization, as part of the prompt sentence and thereby enabling the generative AI model to exploit context unavailable to conventional rule-based parsers.

The server reduces communication load between computational components by aggregating multiple related abnormal entries into a single incident-level input to the generative AI model. This aggregation decreases the number of inference calls and reduces redundant data transfer between the preprocessing module and the inference module. The server also improves data management by systematically associating structured analysis results with incident identifiers in the storage device, enabling efficient indexing and retrieval for future reference or reanalysis.

The server uses processing sequences and data structures that are not mere automation of human cognitive tasks. The server defines explicit mapping rules from structured data fields to tokens in the prompt sentence, and uses controlled natural language elements that are optimized for compatibility with the generative AI model's internal representation space. The server applies non-conventional procedures, such as automatically generating auxiliary instructions in the prompt sentence that constrain the generative AI model to specific output formats, thereby enabling robust machine parsing of inference results. This coupling between prompt construction and structured parsing produces a feedback loop that a human operator alone cannot reliably or consistently implement at scale.

The server, by combining deterministic preprocessing, structured prompt sentence generation, and constrained generative AI model inference, performs an improved form of computer-implemented abnormal analysis. The technical effect includes faster end-to-end analysis from log acquisition to display, due to reduced manual intervention and optimized data flows; higher precision in cause identification, due to the generative AI model's ability to integrate historical abnormal information and solutions encoded in its parameters; and improved reliability of incident handling, due to standardized structured storage of analysis results and consistent notification to the terminal.

In a variation of the embodiment, the server may employ different types of neural network architectures for the generative AI model, such as recurrent neural networks or convolutional networks adapted for text, or may use hybrid models combining rule-based prefilters with the generative AI model. The server may also vary the granularity of structured data fields, for example by including resource hierarchy information, user group information, or process dependency graphs as additional features. The terminal may be implemented as a mobile device or a desktop computer, and may display analysis results in different layouts, such as dashboards or detailed drill-down views.

In another embodiment, the server may deploy multiple generative AI models specialized for different categories of abnormalities, such as database-related issues, network-related issues, or application-level issues. The server selects an appropriate model based on resource name information, error code, or a preliminary classifier, and generates prompt sentences adapted to the selected model's expected input format. The server thereby improves computational efficiency and accuracy by using specialized models for different domains.

In yet another embodiment, the server may dynamically adapt the content of prompt sentences based on performance metrics of previous inferences. For example, when previous analysis results for similar abnormal information have been frequently overridden by user feedback, the server may adjust the prompt sentence to request additional detail or to restrict the generative AI model's speculation. This adaptive prompt refinement further enhances the overall technical performance of the system by aligning internal inference behavior with observed reliability over time.

Through these embodiments and variations, the server, the terminal, and the user cooperate in a computing environment in which unstructured abnormal information is automatically converted into structured data, used to generate optimized prompt sentences for a generative AI model, and transformed into structured analysis results that are efficiently delivered and displayed, thereby realizing concrete improvements in computer technology rather than a mere automation of human mental processes.

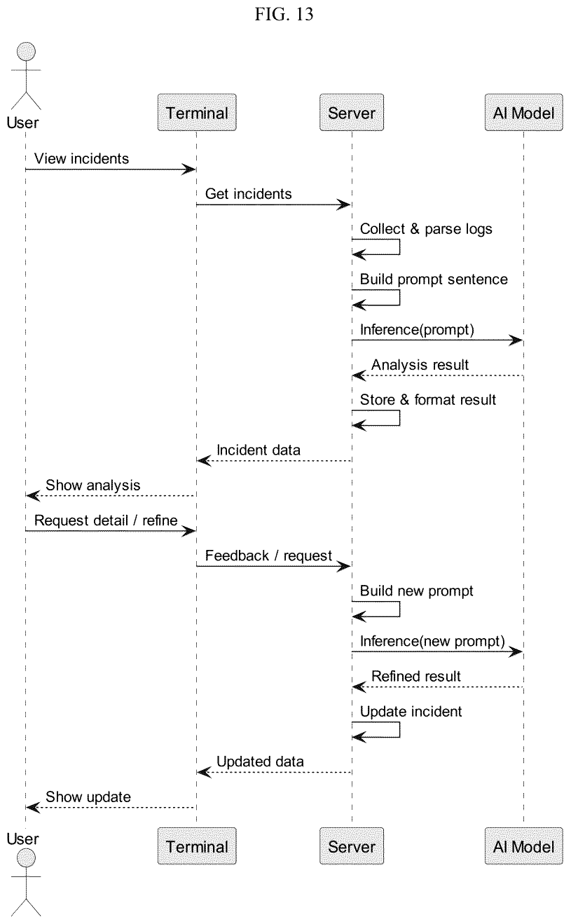

The following describes the processing flow using FIG. 13.

### Step 1

The server acquires raw log data including abnormal information from one or more information processing apparatuses.

The server uses a log collection program to open log files on a local or remote storage device in read-only mode and reads newly appended lines since a stored offset value.

Input: log file segments containing mixed normal and abnormal log lines.

Processing: the server compares each new line against simple patterns (for example, presence of keywords such as “ERROR” or “WARNING” or specific error codes) and discards lines that do not match abnormal patterns. The server updates the stored offset for each log file after reading.

Output: a batch of raw abnormal log lines stored in a temporary buffer in memory.

### Step 2

The server converts the raw abnormal log lines into structured data.

The server applies string processing and regular expression patterns to each raw log line to extract fields such as timestamp, component identifier, process identifier, resource name, error code, and message text.

Input: the batch of raw abnormal log lines from Step 1.

Processing: the server executes pattern matching on each line, parses detected substrings into typed fields (for example, converting a timestamp string into a standard time representation, normalizing component identifiers), and constructs a record object with fixed fields for each abnormal line. The server aggregates these records into an in-memory table and optionally inserts them into a database table for persistence.

Output: structured abnormal log records, each having explicit fields including time information, identification information, resource name information, and event content information.

### Step 3

The server normalizes the structured abnormal log records and groups them into incidents.

The server unifies time zones, standardizes resource names using a mapping table, and detects related records that belong to the same abnormal event.

Input: structured abnormal log records from Step 2.

Processing: the server converts all timestamps to a reference time zone, replaces aliases of resource names with canonical names, and sorts the records by time. The server then clusters records that occur within a preset time window and share common identification information, assigning a unique incident identifier to each cluster.

Output: incident-level structured data, where each incident contains one or more abnormal log records and associated normalized fields.

### Step 4

The server generates a prompt sentence in a natural language for each incident.

The server constructs a textual instruction that describes the incident and specifies the analysis required from the generative AI model.

Input: incident-level structured data from Step 3.

Processing: the server selects key fields such as timestamp of first occurrence, primary component, main resource name, and representative error message. The server fills these values into a predetermined sentence template and appends explicit instructions about required outputs, such as cause, impact range, and recommended actions. The server concatenates the template fragments and field values into a coherent prompt sentence.

Output: a prompt sentence associated with each incident, ready to be sent to the generative AI model.

### Step 5

The server prepares input data for the generative AI model.

The server combines the prompt sentence with auxiliary structured features to form a model input.

Input: the prompt sentence from Step 4 and the corresponding incident-level structured data.

Processing: the server tokenizes the prompt sentence using a tokenizer compatible with the generative AI model, maps tokens to token identifiers, and embeds additional features such as severity indicators or counts of related records as feature tokens or appended textual annotations. The server packages the token sequence and any auxiliary metadata into a request object compatible with the inference engine.

Output: model-ready input data including tokenized prompt content and associated features.

### Step 6

The server executes inference using the generative AI model.

The server passes the prepared input data to a trained neural network model to obtain an analysis result.

Input: model-ready input data from Step 5.

Processing: the server sends the tokenized input to the inference engine, which loads trained parameters of the neural network into memory and performs forward propagation through embedding layers, attention layers, and feedforward layers. The server controls decoding (for example, greedy decoding or beam search) to generate an output token sequence that follows the requested structure (items such as “cause”, “impact_range”, and “recommended_actions”).

Output: a generated text sequence containing the analysis result for the incident, expressed in natural language and logically divided into specified items.

### Step 7

The server parses the generated text sequence into structured analysis data.

The server extracts items corresponding to cause, impact range, and countermeasures from the model output.

Input: generated text sequence from Step 6.

Processing: the server scans the sequence for predefined labels or separators (for example, lines starting with “cause:”, “impact_range:”, and “recommended_actions:”), splits the text at those markers, trims extraneous characters, and converts the parts into structured fields. The server associates these fields with the incident identifier and validates that mandatory fields are present and non-empty.

Output: structured analysis records that describe, for each incident, the content of the abnormality, its cause, its impact range, and one or more recommended actions.

### Step 8

The server stores the structured analysis data and links it with historical data.

The server writes the analysis results into a persistent storage unit for later retrieval and comparison.

Input: structured analysis records from Step 7 and, optionally, existing historical incident data.

Processing: the server inserts or updates records in a database table dedicated to incident analysis, using the incident identifier as a key. The server records timestamps, model version information, and derived metrics such as severity scores. The server may also compute similarity measures between the current incident and stored historical incidents and record references to similar past cases.

Output: persistent incident analysis entries stored in the storage unit, enriched with linkage to historical abnormal information and solutions.

### Step 9

The server generates display data for an information terminal.

The server formats the analysis data into a structure suitable for user interface rendering.

Input: persistent incident analysis entries from Step 8 and corresponding incident-level data.

Processing: the server retrieves the relevant data fields, including incident identifier, time of occurrence, main component, summarized cause text, impact range description, and ordered list of recommended actions. The server arranges these fields into a presentation-oriented structure, possibly including severity classifications and status flags such as “unresolved” or “acknowledged.” The server incorporates pagination or grouping information to support display of multiple incidents.

Output: display data comprising incident summaries and detailed analysis information for transmission to the terminal.

### Step 10

The server transmits the display data to the terminal.

The server sends the formatted analysis results over a communication network to one or more terminals.

Input: display data from Step 9 and destination terminal identifiers or session information.

Processing: the server serializes the display data into a transmittable format, establishes or uses an existing communication session with the terminal, and sends the data using a protocol such as Hypertext Transfer Protocol over a secure connection. The server may also send notifications indicating that new incident analysis is available.

Output: transmitted display data received by the terminal.

### Step 11

The terminal receives and renders the display data for the user.

The terminal processes the received information and presents it on a display device.

Input: display data transmitted from the server in Step 10.

Processing: the terminal deserializes the received data, maps its fields to user interface components, and draws a screen showing incident lists and selected incident details, including the cause, impact range, and recommended actions. The terminal may also highlight critical incidents and provide controls for filtering or sorting.

Output: a visual representation of incident analysis on the display device, accessible to the user.

### Step 12

The user interacts with the terminal to review and act on the incident analysis.

The user inspects the abnormality details and may trigger further actions or requests.

Input: the visual representation of incident analysis displayed by the terminal in Step 11.

Processing: the user reads the cause and impact range descriptions, evaluates the recommended actions, and uses input devices to select an incident, mark it as acknowledged or resolved, or request additional detail. The user may also input a free-form request, such as asking for less disruptive countermeasures, via a text field on the terminal.

Output: user interaction commands and additional textual input sent from the terminal back to the server.

### Step 13

The terminal sends user interaction data to the server.

The terminal communicates the user's commands and requests for further analysis.

Input: user interaction commands and additional textual input from Step 12.

Processing: the terminal packages the user selections and input text, associates them with corresponding incident identifiers, and transmits these data to the server using a secure communication channel.

Output: user feedback and re-analysis requests received by the server.

### Step 14

The server optionally performs re-analysis using updated prompt sentences.

The server refines the prompt sentence based on user feedback and executes another inference cycle.

Input: user feedback and re-analysis requests from Step 13, along with stored incident-level structured data and previous analysis records.

Processing: the server constructs an extended prompt sentence that includes a summary of the previous analysis and the user's additional requirements, such as “propose a non-disruptive recovery procedure” or “estimate the risk of data loss.” The server then repeats the preparation of model input data, inference, parsing, storage, and display data generation as in Steps 5 through 9, but with updated content.

Output: updated structured analysis records and revised display data reflecting refined cause assessments and revised recommended actions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional error-handling and monitoring systems for information processing apparatuses typically rely on fixed rule sets, static alert thresholds, and manually written troubleshooting guides. Such systems face several technical problems. First, the mapping from heterogeneous machine-generated data (for example, log messages, performance metrics, and sensor outputs) to a structured representation of “what is wrong” is often ad hoc and brittle, resulting in inaccurate anomaly classification and frequent false alerts. Second, even when an anomaly is correctly detected, the generation of an appropriate resolution procedure generally requires human experts to interpret the raw data and compose natural-language instructions, which introduces latency, inconsistency, and heavy operational load. Third, conventional systems do not systematically use end-user feedback about the effectiveness of proposed resolutions to refine the underlying models or prompt generation logic, so the quality of automated support does not improve over time. Fourth, when user interaction is provided via natural language, conventional systems do not adapt the level of technical detail, ordering of steps, or tone of explanations to the real-time emotional state of the user, which can lead to confusion, misapplication of procedures, and additional support load.

From a computer-technology perspective, existing systems fail to integrate discriminative machine learning models (for anomaly typing and cause inference) and generative machine learning models (for natural-language explanation and procedure synthesis) into a closed feedback loop that operates directly on machine-generated operational data and user interaction signals. In particular, conventional architectures lack: (i) a processor that programmatically constructs rich prompt sentences for a generative AI model based on structured anomaly features, model-inferred cause candidates, historical effectiveness data, and current user emotion; and (ii) a mechanism to update both discriminative and generative components, as well as prompt generation rules, based on explicit execution-result feedback from end users.

As a result, conventional systems exhibit technical limitations such as inefficient utilization of compute and storage resources due to repeated manual diagnosis, sub-optimal model behavior that is not tuned to operational feedback, and poor human-machine interaction quality that degrades troubleshooting throughput and increases mean time to resolution. There is therefore a need for a computer-implemented technique that automatically converts raw operational data into structured anomaly representations, dynamically generates optimized prompt sentences for a generative AI model, and adaptively refines both discriminative and generative behavior based on measured effectiveness and user emotional state, thereby improving the overall performance and reliability of the error-handling infrastructure.

The specific processing by the specific processing unit 290 of the data processing device 12 in Application Example 2 is realized by the following means.

The present invention provides a server comprising a processor and a memory storing instructions which, when executed by the processor, cause the processor to monitor an operating state of an information processing apparatus, generate anomaly information based on log information, performance indicator information, and detector information output from the information processing apparatus, preprocess the anomaly information, the log information, and the performance indicator information into structured data, input the structured data into a discriminative learning model to specify an anomaly type, an impact range, and candidate causes, and generate a prompt sentence including contents of the anomaly, the impact range, and the candidate causes and defining an output style and a level of explanation detail; input the prompt sentence into a generative learning model, cause the generative learning model to generate, in a natural language, an explanation and a stepwise resolution procedure in accordance with the contents of the anomaly and the candidate causes, store a generation result in association with the anomaly information and history information, and transmit the generation result to a terminal device; estimate an emotional state of a user based on voice information, image information, or text information acquired from the terminal device or a voice input device, and include the emotional state in the prompt sentence so as to cause the generative learning model to adjust a writing style, the level of explanation detail, and proposal contents of the explanation in accordance with the emotional state of the user; and acquire an execution result of the resolution procedure and evaluation information thereof from the terminal device, store the evaluation information in association with the anomaly information, the prompt sentence, and the generation result, and update at least one of operation of the discriminative learning model, operation of the generative learning model, and a generation rule of the prompt sentence based on an accumulation result of the evaluation information. This enables the computing system to automatically transform heterogeneous operational data into structured anomaly representations, dynamically generate optimized natural-language troubleshooting procedures via a generative AI model, and continuously refine both discriminative and generative behaviors in response to real-world effectiveness metrics and user emotional context, thereby improving technical performance metrics such as diagnosis accuracy, response latency, resource utilization, and overall reliability of computer-implemented error-handling processes.

The term “system” refers to an integrated combination of hardware and software components, including at least one processor, memory, and communication interface, that cooperatively perform the claimed processing.

The term “processor” refers to one or more hardware processing units, such as a central processing unit or a processing core, configured to execute instructions to perform logical and arithmetic operations described in the claims.

The term “information processing apparatus” refers to an electronic apparatus that performs data input, data processing, and data output operations, including but not limited to servers, client devices, controllers, and computing nodes.

The term “operating state” refers to a condition of the information processing apparatus during operation, including at least one of resource utilization, functional status, performance behavior, and error occurrence.

The term “log information” refers to data records automatically generated by the information processing apparatus during operation, the data records including at least one of event messages, error messages, system messages, and application messages.

The term “performance indicator information” refers to quantitative metrics representing performance of the information processing apparatus, including at least one of processor utilization, memory usage, storage usage, and communication throughput.

The term “detector information” refers to measurement data obtained from sensors or monitoring components associated with the information processing apparatus, including at least one of temperature values, vibration values, voltage values, and other environmental or operational measurements.

The term “anomaly information” refers to data representing an abnormal condition of the information processing apparatus, the data being derived from at least one of the log information, the performance indicator information, and the detector information.

The term “preprocess” refers to performing data transformation operations on input data, including at least one of cleaning, normalizing, extracting features, and converting the input data into a structured representation suitable for machine learning.

The term “structured data” refers to data organized into a predefined format, including fields or attributes such as identifiers, timestamps, metric values, and feature vectors, that can be directly provided as input to a machine learning model.

The term “discriminative learning model” refers to a machine learning model configured to map input data to one or more labels or numerical values, and to perform tasks such as classification, regression, anomaly detection, and cause estimation.

The term “anomaly type” refers to a category or label indicating a classified kind of abnormal condition, including examples such as a network anomaly, a storage anomaly, a processing anomaly, or an application anomaly.

The term “impact range” refers to a scope of influence of the anomaly, including at least one of affected components, affected services, affected data sets, and affected users.

The term “candidate causes” refers to one or more possible causes of the anomaly inferred from the structured data and outputs of the discriminative learning model.

The term “prompt sentence” refers to a natural-language or semi-structured instruction string generated by the processor, the instruction string specifying information about the anomaly and request conditions to be provided as input to a generative learning model.

The term “output style” refers to a pattern or format of textual output generated by the generative learning model, including at least one of tone, level of formality, and structural layout of explanation and steps.

The term “level of explanation detail” refers to an extent of technical depth and granularity of information in the explanation, including at least one of a brief summary level, an intermediate detail level, and a full step-by-step detail level.

The term “generative learning model” refers to a machine learning model configured to generate sequences of output data, including at least one of natural-language text and structured instructions, in response to input data such as the prompt sentence.

The term “natural language” refers to a human language representation, such as sentences or phrases that can be understood by a human user without special encoding or programming syntax.

The term “stepwise resolution procedure” refers to a sequence of one or more ordered steps represented in natural language, the sequence specifying operations to be executed to mitigate or resolve the anomaly.

The term “generation result” refers to content output by the generative learning model, including at least one of explanations, resolution procedures, warnings, and recommendations.

The term “history information” refers to previously stored data related to past anomalies, corresponding prompt sentences, generation results, and execution outcomes.

The term “storage device” refers to one or more physical storage elements, such as semiconductor memory or magnetic storage, used to store at least the anomaly information, the prompt sentences, the generation results, and evaluation information.

The term “terminal device” refers to an apparatus used by a user to receive notifications, display information, and input data, including at least one of a personal computer, a handheld computing device, and a console device.

The term “voice input device” refers to a device configured to acquire voice information from a user, including at least one of a microphone and a voice-input interface integrated in the terminal device.

The term “voice information” refers to audio data representing spoken utterances of a user, including at least one of raw audio signals and processed acoustic features.

The term “image information” refers to visual data representing a user or an environment, including at least one of still images and moving images captured by an image sensor.

The term “text information” refers to character-based data input or generated for interaction with the system, including at least one of typed messages, chat content, and transcribed speech.

The term “emotional state” refers to an estimated psychological state of a user, including categories such as anger, confusion, stress, satisfaction, and calmness, derived from the voice information, the image information, or the text information.

The term “writing style” refers to a textual expression pattern, including at least one of politeness level, directness, technical wording, and sentence complexity in the generated explanation.

The term “proposal contents” refers to specific elements contained in the generated resolution procedure, including at least one of recommended actions, cautions, and optional alternative steps.

The term “execution result” refers to data representing an outcome of performing at least a part of the stepwise resolution procedure in an operational environment.

The term “evaluation information” refers to feedback data indicating a degree of success, failure, or usefulness of the generated explanation or resolution procedure, including at least one of binary indicators, ratings, and textual comments.

The term “operation of the discriminative learning model” refers to behavior of the discriminative learning model, including parameter settings, selection of sub-models, and decision thresholds applied during inference.

The term “operation of the generative learning model” refers to behavior of the generative learning model, including parameter settings, decoding strategies, and sampling policies used when generating output.

The term “generation rule of the prompt sentence” refers to a set of conditions, templates, or algorithms used to determine structure, contents, and wording of the prompt sentence derived from input data and model outputs.

The term “similarity” refers to a numerical or categorical measure representing a degree of resemblance between a current anomaly and past anomaly information, computed based on features extracted from the structured data.

The term “resolution procedure with high effectiveness” refers to a resolution procedure associated with evaluation information indicating favorable outcomes, including higher success rates, shorter resolution times, or more positive user feedback, relative to other resolution procedures.

In one embodiment, a server includes a processor, a main memory, a non-volatile storage device, and a network interface, and executes an operating system and middleware for log collection, data storage, and machine learning computation. The server executes a program that implements the functions of monitoring an operating state of one or more information processing apparatuses, generating anomaly information, constructing a prompt sentence, invoking a generative AI model, and updating model behavior based on feedback. The information processing apparatuses include, for example, industrial controllers, application servers, database servers, and manufacturing robots. A terminal includes a processor, a display, an input interface, an audio input device, and optionally an image capture device, and executes an application that communicates with the server, displays explanation and resolution procedures, and transmits user feedback and emotional cues.

The server uses log-collection software, such as a general log forwarder and an event streaming agent, to receive log information from the information processing apparatuses. The server also obtains performance indicator information such as processor utilization, memory usage, storage I/O throughput, and network packet rates, for example via an operating system metrics interface. The server further acquires detector information such as temperature, vibration, flow rate, or electric current from sensors attached to machines or control devices via an industrial fieldbus or an IP-based protocol.

The server stores the log information, the performance indicator information, and the detector information in a relational database system executing on the same hardware or a separate storage system. The database organizes data into tables for raw logs, time-series metrics, sensor readings, anomaly records, prompt sentences, generative outputs, and feedback. Each record is associated with identifiers such as a device identifier, a process identifier, a timestamp in a standardized format, and an anomaly record identifier.

The server executes a discriminative learning model implemented with a machine learning framework such as a generic tensor computation library. In one implementation, the discriminative learning model is a multi-layer neural network that combines a text encoder and a numerical feature encoder. The text encoder is, for example, a recurrent neural network, a convolutional neural network, or a transformer-based encoder that consumes tokenized log messages. The numerical feature encoder is, for example, a feedforward neural network that consumes performance indicator vectors and detector vectors normalized to zero mean and unit variance. The outputs of the text encoder and the numerical feature encoder are concatenated into a joint feature vector.

The server inputs the joint feature vector into classifier layers that compute probabilities over anomaly types, potential impact ranges, and candidate causes. The classifier layers are constructed as fully connected layers with non-linear activation functions, such as rectified linear units, and a final softmax function per output head. The anomaly type head outputs a distribution over defined categories such as “network anomaly,” “storage anomaly,” “processor overload,” “robot position deviation,” and “database inconsistency.” The impact range head outputs a distribution over affected component sets such as “single node,” “cluster of nodes,” or “entire production line.” The candidate cause head outputs a ranked list or distribution over cause candidates such as “configuration error,” “resource exhaustion,” “sensor miscalibration,” or “mechanical wear.”

The server trains the discriminative learning model offline or online using historical labeled data stored in the database. Each training sample includes input features derived from past log information, performance indicator information, and detector information, together with labels representing ground-truth anomaly types, impact ranges, and causes. The server uses supervised learning with a loss function composed of a weighted sum of cross-entropy terms for each output head. The server updates model weights using a gradient-based optimization algorithm such as stochastic gradient descent or a variant thereof. The server may perform data augmentation by perturbing numeric metrics within physically meaningful ranges or by injecting synthetic log segments to improve robustness.

The server constructs anomaly information records when certain detection conditions are met. The server uses a rule engine that applies threshold tests and pattern detection on the incoming performance indicator information and detector information. For example, if a processor utilization metric exceeds a predetermined percentile threshold for a specified duration, or if a vibration amplitude increases beyond a learned baseline, the server creates an anomaly information record referencing the underlying measurements. The server additionally lets the discriminative learning model produce anomaly scores that represent deviation from normal behavior; if the score exceeds a learned boundary, the server generates an anomaly information record even when fixed thresholds are not crossed. This hybrid approach allows the server to detect previously unseen anomaly patterns while still capturing known failure modes.

After establishing an anomaly information record, the server retrieves the relevant log lines, performance indicator samples, and detector readings over a time window surrounding the anomaly time. The server preprocesses the log text by tokenizing it using a vocabulary built from historical logs, mapping tokens to numerical indices, and truncating or padding sequences to a fixed length. The server preprocesses the performance indicator information and detector information by resampling or aggregating them into fixed-length numeric vectors. This concrete structuring of heterogeneous data into a uniform feature representation enables efficient computation in the discriminative learning model and avoids ad hoc, device-specific parsing that was required in conventional systems.

The server then executes the discriminative learning model on the preprocessed data to obtain predicted anomaly type, impact range, and candidate causes along with confidence scores. Because the neural network internally combines temporal information from log sequences and multi-dimensional numerical metrics, the prediction reflects complex cross-correlations that are difficult for rule-based systems or human operators to exploit in real time. As a result, the server can classify anomalies and propose cause candidates more quickly and accurately than prior approaches.

Based on the discriminative model outputs and the structured data, the server generates a prompt sentence for a generative AI model. The server uses a prompt construction module that applies templates and rules to insert concrete values such as device identifiers, timestamps, anomaly type labels, candidate causes, and impact range into a natural-language instruction string. The prompt construction module also incorporates a desired output style and level of explanation detail, which the server sets according to system policies and, in certain embodiments, according to an estimated emotional state of the user.

For example, the server can generate a prompt sentence such as: “Analyze the following error data and propose root causes and stepwise resolution procedures. Device: server-01. Anomaly type: database inconsistency. Candidate causes: configuration mismatch, incomplete schema migration. Impact range: orders table and related transactions. Provide a concise explanation and a prioritized list of actions.”

In another case, when the user is determined to be confused, the server generates a more detailed prompt sentence such as: “The user feels confusion. Explain in simple terms what is causing the database inconsistency on device db-cluster-A. Anomaly type: database inconsistency. Candidate causes: data type mismatch, partial migration. Provide a very detailed, step-by-step troubleshooting guide suitable for a non-expert operator.”

In a manufacturing environment, the server may generate a prompt sentence such as: “The motor rotation speed is decreasing below normal range on production line 3. Detector data indicate increased vibration. Candidate cause: bearing wear. Explain the most probable causes and recommend maintenance actions, including inspection intervals and replacement steps.”

These prompt sentences are not static text but are programmatically assembled from structured features and model outputs. This represents a non-conventional use of prompt construction logic that leverages model-inferred features and historical effectiveness data, rather than merely echoing raw logs.

The server executes a generative AI model, implemented for example as a transformer-based sequence-to-sequence neural network configured for natural-language generation. The generative AI model receives the prompt sentence as input and produces an output sequence representing an explanation and a stepwise resolution procedure. Internally, the generative AI model applies token embedding, positional encoding, multi-head self-attention, feedforward layers, and a decoding algorithm such as beam search or top-k sampling. The server may also condition generation on additional context vectors representing retrieved similar cases from the database, by concatenating context embeddings with the prompt embedding or by cross-attention mechanisms.

The server trains or fine-tunes the generative AI model using a corpus of historical anomaly cases and associated human-written or previously validated resolution procedures. During training, the server minimizes a sequence-level loss function such as negative log-likelihood of the target tokens, optionally combined with regularization terms that penalize excessively long outputs or unsafe suggestions. The server updates model parameters via gradient-based optimization, using mini-batches and learning-rate scheduling. By explicitly training the generative AI model on domain-specific troubleshooting text aligned with structured anomaly features, the server improves the technical properties of the generated instructions, including accuracy of terminology and coverage of necessary steps.

The server stores the generative output, including an explanation section and a stepwise resolution procedure, in association with the corresponding anomaly information and prompt sentence in the database. The server then notifies the terminal via a network connection, for example using a web application framework that transmits a structured payload to the terminal, which is then rendered as text on a graphical user interface. The terminal displays, for instance, a headline summarizing the anomaly type, a paragraph explaining the root cause, and a numbered list of recommended actions. The terminal can color-code severity and provide interactive controls to mark steps as completed.

The terminal optionally captures user emotional cues. For example, the terminal application can capture voice information via a microphone when the user is speaking to a support interface, or capture image information via a camera to observe facial expressions, or receive text information from a chat input. The terminal locally extracts features such as pitch contours, speech rate, facial muscle movement patterns, or sentiment scores from the text. The terminal either runs a local emotion classification model or transmits the extracted features to the server for classification. The emotion classification model may be a neural classifier trained to output probabilities over emotional state categories. The server receives the emotion label and confidence value, and records them in association with the active anomaly case.

By including the emotional state in subsequent prompt sentences, the server modifies the generative AI model's behavior in a technically meaningful way. For example, when the user is classified as “angry,” the server sets the output style to be concise and action-oriented, reduces the requested explanation depth, and asks the model to prioritize immediate mitigation steps. When the user is classified as “confused,” the server requests more detailed explanations, additional background information, and slower stepwise procedures. This dynamic adjustment is implemented by adding explicit instructions in the prompt sentence, such as: “The user is angry. Provide a short, direct explanation and focus on the fastest mitigation steps.”

or

“The user is confused. Provide a detailed, beginner-friendly explanation, and include background information for each step.”

This configuration changes the internal token distribution produced by the generative AI model, leading to output that is technically more appropriate for the user's state, thereby reducing the risk of misinterpretation and repeated support queries. Since the adjustment is performed through structured prompt construction, it represents a concrete modification of the computer's text generation process, not merely a human-level stylistic choice.

The server also acquires execution results and evaluation information from the terminal. After the user performs some or all of the recommended steps, the terminal provides structured feedback such as a binary success indicator, a numerical rating of usefulness, and optional free-form comments. The server records this evaluation information in the database, linked to the anomaly record, prompt sentence, and generative output. The server uses this accumulated data to refine both discriminative and generative models and the prompt generation rules.

In one implementation, the server uses the evaluation information to weight training samples during subsequent retraining or fine-tuning. Cases with high success ratings are given higher weight, while cases marked as unsuccessful are used to adjust the models away from previously generated patterns. The server may compute a reward signal based on success and use a policy-gradient or reinforcement-learning-style update to encourage the generative AI model to produce outputs that historically led to successful resolution. For the discriminative learning model, the server uses discrepancies between predicted and actual causes, as inferred from successful resolutions, to update model parameters and decision thresholds, thereby reducing future misclassifications.

This feedback-driven refinement results in a technical improvement over static models. The server automatically adapts to changing system configurations and failure modes without requiring manual rule updates. Because the model updates are supported by structured feedback and integrated with prompt generation logic, the system avoids naive overfitting and maintains stability.

In another embodiment, the server retrieves past anomaly information and corresponding resolution procedures from the database to assist in generating new prompt sentences. The server computes a similarity measure between current anomaly features and historical cases using vector similarity metrics such as cosine similarity on learned embeddings. The server then includes the most similar cases and their outcomes in the prompt sentence, for example: “Past similar cases: 3 examples where data inconsistency occurred due to schema mismatch; resolutions with highest success involved re-applying migration script X and running integrity checks. Use these examples to propose a resolution.”

By explicitly instructing the generative AI model to consider high-effectiveness historical procedures, the server exploits the structure of the historical data to improve both speed and quality of inference.

The system yields technical effects in multiple dimensions. First, because the discriminative learning model processes structured data using optimized tensor operations, the server performs anomaly classification and cause inference at machine speed, significantly reducing mean time to diagnosis compared to manual log inspection. Second, by moving from fixed rule-based resolution scripts to a generative model conditioned on rich prompt sentences, the server can synthesize context-sensitive, stepwise procedures that better match the current system configuration, reducing unnecessary steps and thereby reducing computational and operational overhead. Third, the dynamic adaptation of output style and detail level based on user emotional state reduces repeated interactions and misunderstandings, which in turn lowers communication load and reduces total processing cycles required for support.

Moreover, the server's explicit structuring of heterogeneous data into joint feature vectors and anomaly embeddings, combined with automated prompt construction and feedback-based model refinement, represents a non-conventional improvement to the internal operation of the computer. The system does not simply automate a human process; rather, it uses feature-level correlations that are impractical for humans to compute in real time, and it organizes and updates models and prompts in a way that increases prediction accuracy, decreases false positives, and improves language generation quality as measured by success metrics.

In another embodiment, the server controls external equipment more directly. For example, in a factory setting, when the generative AI model generates a stepwise resolution procedure for a suspected bearing failure, the server may include commands that reduce motor speed or temporarily stop a production line to prevent further damage. The terminal presents these commands as interactive options, and upon user approval, the server transmits standardized control signals to a programmable logic controller. Because the anomaly detection and cause estimation are based on a combination of sensor data and performance metrics processed by the discriminative learning model, the system can trigger such protective actions quickly and with higher confidence, thereby reducing mechanical failure risk and associated downtime.

Alternative embodiments can vary the models and algorithms while maintaining the same fundamental architecture. For example, the discriminative learning model can be implemented as a gradient-boosted decision tree or a hybrid model that combines a recurrent unit for logs and a tree-based model for numeric features. The generative AI model can be a sequence-to-sequence recurrent neural network with attention, rather than a transformer, and can be pruned or quantized for deployment on resource-limited servers. The emotion classification model can use different feature sets, such as keyboard typing dynamics or mouse movement patterns, in addition to or instead of voice and image data.

The server can also implement different prompt generation rules for different domains. In a database administration domain, prompt sentences emphasize table names, query patterns, and transaction isolation levels. In a robotics domain, prompt sentences emphasize joint identifiers, position errors, and safety interlock states. Differences in prompt structure cause the generative AI model to produce technically distinct instruction sequences that are tuned to the domain, improving effectiveness.

In all embodiments, the server, the terminal, and the user interact through a defined data flow in which the server performs intensive numerical inference and text generation, the terminal captures local context and emotion signals and displays outputs, and the user executes physical or administrative actions on real systems. This configuration grounds the claimed generative AI and prompt sentence mechanisms in concrete computer-implemented operations that improve the way computers diagnose anomalies, generate instructions, and adapt over time, rather than merely automating a human process at an abstract level.

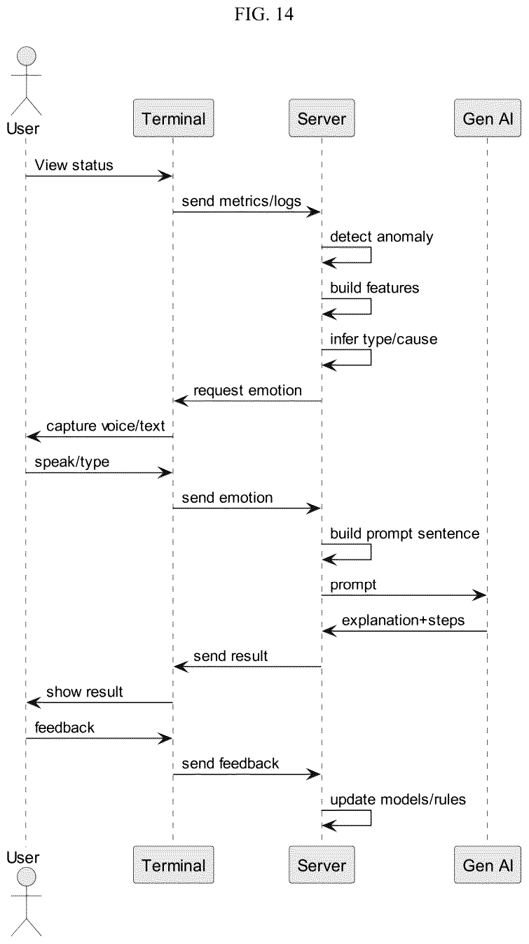

The following describes the processing flow using FIG. 14.

### Step 1

Server collects raw operational data from information processing apparatuses.

Server receives, as input, log information (event messages, error messages), performance indicator information (CPU usage, memory usage, I/O throughput, network traffic), and detector information (temperature, vibration, current) via a network interface and log-collection agents.

Server writes, as output, raw records into a storage device in separate tables or data structures, each record including at least a device identifier, a timestamp, a source type, and a raw payload field.

Server performs data processing by parsing incoming messages, attaching metadata (device ID, process ID, severity), and buffering records before batch insertion into a relational database.

### Step 2

Server detects candidate anomalies from the raw data.

Server reads, as input, recently stored log information, performance indicator information, and detector information from the database and in-memory buffers.

Server computes, as data processing, threshold checks (for example, CPU usage greater than a configured limit for a minimum duration), statistical deviations (for example, vibration amplitude exceeding a learned baseline by a multiple of standard deviation), and pattern matches on log strings (for example, presence of known error codes).

Server outputs anomaly information records that contain anomaly timestamps, source devices, preliminary anomaly types (rule-based), and references to the underlying raw data segments, and stores these records in an anomaly table marked as “pending analysis.”

### Step 3

Server assembles context windows around each anomaly.

Server receives, as input, anomaly information records and the identifiers of associated devices and timestamps.

Server queries, as data processing, the database for log information, performance indicator information, and detector information within a configured time window before and after each anomaly timestamp. Server aggregates performance indicators into fixed-interval time series and extracts contiguous log segments.

Server outputs structured context packages that include a time-ordered list of log entries, time-aligned vectors of metrics, and sampled detector readings, and associates each package with a unique anomaly identifier.

### Step 4

Server preprocesses textual and numerical features for model input.

Server receives, as input, structured context packages containing log text, metric sequences, and detector readings.

Server performs data processing by tokenizing log text into tokens using a vocabulary, mapping tokens to integer IDs, truncating or padding each token sequence to a fixed length, normalizing numerical metrics (for example, subtracting mean and dividing by standard deviation), and resampling or interpolating detector readings to fixed time steps. Server concatenates numerical features into fixed-length vectors.

Server outputs, for each anomaly, a combined feature representation consisting of a token ID matrix for logs and a numerical feature vector for performance and detector data, which is formatted as a tensor suitable for input to the discriminative learning model.

### Step 5

Server infers anomaly type, impact range, and candidate causes using a discriminative learning model.

Server receives, as input, the token ID matrix and numerical feature vector for each anomaly.

Server performs data computation by executing a discriminative neural network model: the server embeds tokens into dense vectors, passes them through an encoder architecture (for example, recurrent, convolutional, or transformer layers), processes numerical features through feedforward layers, concatenates encoded text and numerical features into a joint feature vector, and applies classification heads with softmax outputs.

Server outputs predicted anomaly type labels, impact range labels, and ranked candidate causes with confidence scores, and stores these inference results in association with the anomaly information records.

### Step 6

Server retrieves relevant historical cases and effectiveness information.

Server receives, as input, anomaly type, candidate causes, and numerical feature vectors for the current anomaly, together with access to historical anomaly records and evaluation information in the database.

Server computes, as data processing, similarity scores between the current anomaly feature vector and stored feature vectors of past anomalies using similarity measures such as cosine similarity or Euclidean distance. Server filters past cases by matching anomaly type or overlapping candidate causes and sorts them by similarity and success ratings from evaluation information.

Server outputs a set of top-k similar historical cases, including their resolution procedures and success metrics, and passes this set to a prompt construction module.

### Step 7

Server estimates a user emotional state when available.

Server receives, as input, voice information, image information, or text information from the terminal or a voice input device, each tagged with a user identifier and, optionally, a reference to an active anomaly case.

Server performs data processing by extracting features such as acoustic descriptors from voice, facial landmarks from images, or sentiment scores from text, and then applying an emotion classification model that outputs probabilities for emotional categories such as anger, confusion, or calmness.

Server outputs an emotional state label and a confidence value, and stores them in association with the user and the current anomaly; the emotional state label becomes part of the context used for prompt sentence generation.

### Step 8

Server generates a prompt sentence for a generative AI model.

Server receives, as input, the anomaly information (type, impact range, candidate causes), the structured context, the selected historical cases with success ratings, and the emotional state label, if available.

Server performs data processing by filling template fields and applying prompt-generation rules: inserting device identifiers, anomaly descriptions, summarized metrics, cause candidates, and representative historical resolutions, and selecting instructions for output style and level of detail according to emotional state and policy.

Server outputs a natural-language prompt sentence, such as:

“Analyze the following error data and propose root causes and stepwise resolution procedures. Device: server-01. Anomaly type: database inconsistency. Candidate causes: configuration mismatch, incomplete schema migration. Past similar cases show that re-applying the migration and running integrity checks were effective. The user is confused. Provide a very detailed, beginner-friendly explanation and a numbered list of actions.”

Server records this prompt sentence together with its associated anomaly identifier.

### Step 9

Server invokes the generative AI model with the prompt sentence.

Server receives, as input, the prompt sentence and, optionally, encoded representations of similar historical cases.

Server performs data computation by transforming the prompt sentence into tokens, embedding them into vectors, feeding them through a generative neural architecture (for example, a transformer-based sequence-to-sequence model), computing attention over the prompt tokens and optional context embeddings, and decoding an output token sequence using a controlled sampling or beam search strategy to satisfy length, safety, and style constraints.

Server outputs a generative result consisting of a natural-language explanation and a stepwise resolution procedure, and stores this result as text linked to the anomaly and the originating prompt sentence.

### Step 10

Server post-processes and validates the generated explanation and procedures.

Server receives, as input, the raw generative result from the generative AI model.

Server performs data processing by splitting the text into sections (for example, “Summary,” “Cause Explanation,” “Actions”), detecting and removing unsafe or unsupported operations by comparing against a whitelist and blacklist of commands, ensuring that references (for example, table names, device IDs) exist in known configuration data, and reformatting steps into a numbered list.

Server outputs a sanitized and structured explanation object, which includes titles, paragraphs, and a list of executable or manual steps, and stores this object for delivery to the terminal.

### Step 11

Server transmits the explanation and procedures to the terminal.

Server receives, as input, the structured explanation object and a target terminal identifier associated with the user or operator responsible for the affected apparatus.

Server performs data processing by wrapping the explanation object into a message payload with metadata such as severity, priority, and anomaly identifier, and then sends the payload via a network protocol (for example, HTTP or a push channel) to the terminal.

Server outputs a network message that, when received by the terminal, triggers a UI update and alert presentation to the user.

### Step 12:

Terminal displays the explanation and resolution steps to the user.

Terminal receives, as input, the message payload containing the explanation object and metadata from the server.

Terminal performs data processing by parsing the payload, mapping severity to visual indicators (for example, colors, icons), and rendering the explanation text and stepwise procedure on a display using a graphical user interface framework. Terminal creates interactive elements such as checkboxes for each step and buttons to request more detail or run automated actions.

Terminal outputs a visual presentation on the display and an interactive interface through which the user can read, acknowledge, and act on the instructions.

### Step 13

User reviews the instructions and executes corrective actions.

User receives, as input, the displayed explanation and stepwise resolution procedure on the terminal.

User performs, as concrete actions, the operations indicated by the steps, which may include adjusting configuration parameters on a server, re-running a migration tool, recalibrating a robot position, slowing or stopping a motor, or checking physical connections. Based on the results observed in the real system, the user decides whether the anomaly has been resolved.

User outputs implicit results at the apparatus level (for example, normal operation restored) and explicit feedback provided through the terminal interface.

### Step 14

Terminal collects user feedback and emotional cues after execution.

Terminal receives, as input, user interactions such as clicking “resolved” or “not resolved,” entering comments on the usefulness of instructions, rating the clarity of explanations, and, if enabled, additional voice or text sequences reflecting the user's state.

Terminal performs data processing by structuring the feedback into fields (for example, success flag, rating score, comment text) and optionally updating emotion estimates based on post-resolution speech or text sentiment.

Terminal outputs a feedback object that includes execution result, evaluation information, and any updated emotional state, and transmits this object to the server along with the associated anomaly identifier.

### Step 15

Server records feedback and updates learning data.

Server receives, as input, the feedback object from the terminal, including execution result, evaluation information, and updated emotional state.

Server performs data processing by writing the feedback fields into feedback tables linked to anomaly records, prompt sentences, discriminative model outputs, and generative results, and by updating aggregated statistics such as success rates per cause, per resolution pattern, and per prompt configuration.

Server outputs updated training and evaluation datasets, which are used in subsequent training or fine-tuning sessions for the discriminative learning model and the generative AI model.

### Step 16

Server refines models and prompt generation rules based on accumulated feedback.

Server receives, as input, accumulated historical records containing anomaly features, model predictions, prompt sentences, generative outputs, and evaluation information.

Server performs data computation by selecting training batches that emphasize cases with strong feedback signals, recalculating loss functions that include penalties for predictions associated with low success rates, and updating model weights through gradient descent. Server additionally analyzes correlations between prompt configurations (for example, style instructions, inclusion of historical examples) and success metrics, and adjusts prompt generation rules, such as deciding when to include past successful resolutions or when to request more detailed output.

Server outputs updated discriminative model parameters, updated generative model parameters, and revised prompt generation rules, deploying them into the runtime environment. This update changes subsequent inference and text generation behavior, so future anomalies are classified more accurately and resolved more effectively.

### Step 17

Server optionally controls external equipment or triggers automated scripts based on generated procedures and confidence levels.

Server receives, as input, the sanitized stepwise resolution procedure, internal confidence measures from the discriminative learning model, and policy rules describing which actions can be automated.

Server performs data processing by identifying steps that correspond to safe automated operations (for example, reducing a load setpoint, restarting a non-critical service) and mapping these steps to machine control commands or management scripts. When policy permits, and optionally after explicit user approval conveyed through the terminal, server sends control messages to programmable controllers or executes scripts on the affected information processing apparatus.

Server outputs concrete control signals or process restarts that directly influence the operation of external devices or software components, thereby closing the loop from anomaly detection and AI-assisted reasoning to real-world corrective action.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

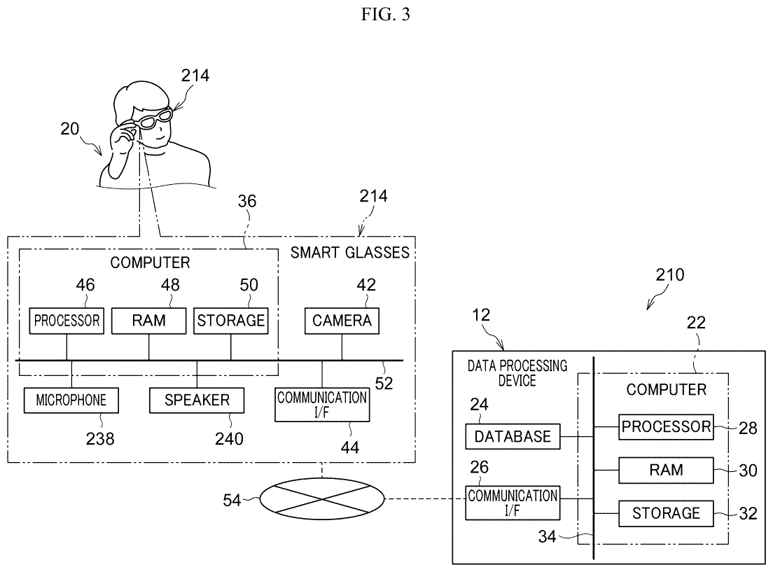

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

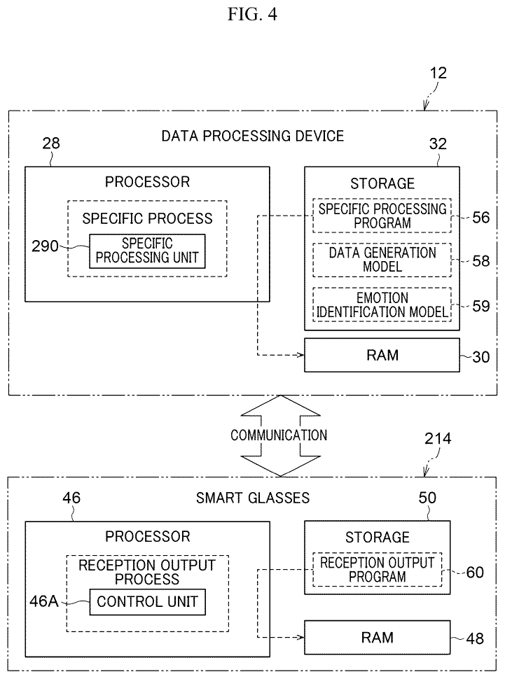

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

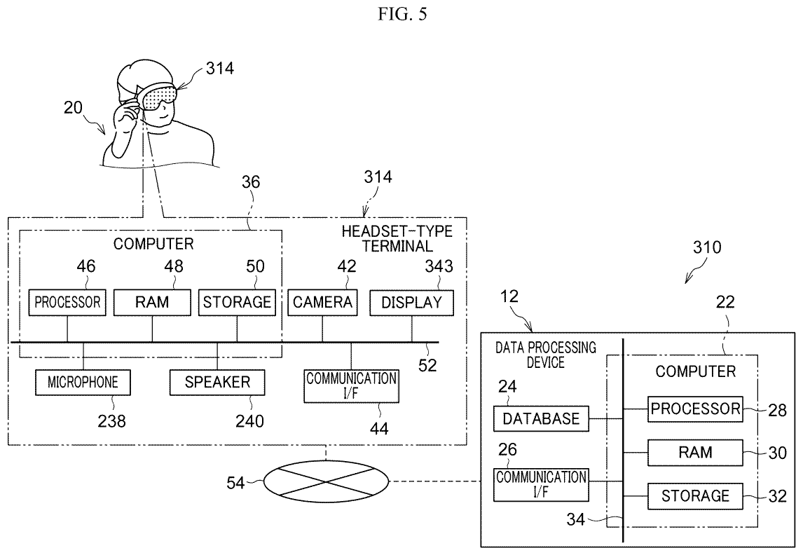

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

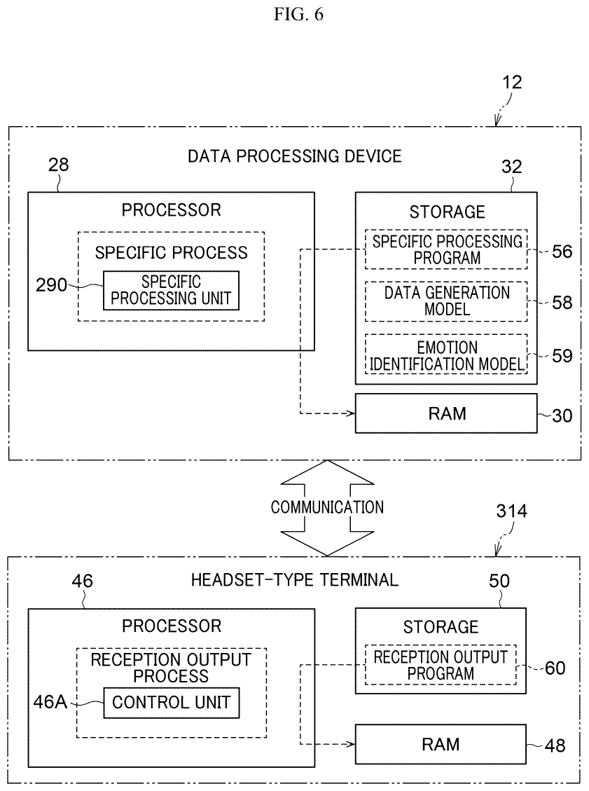

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

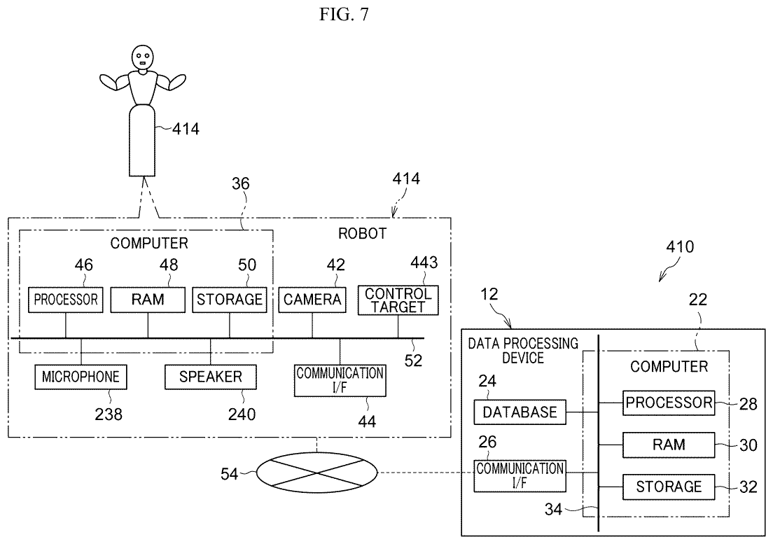

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

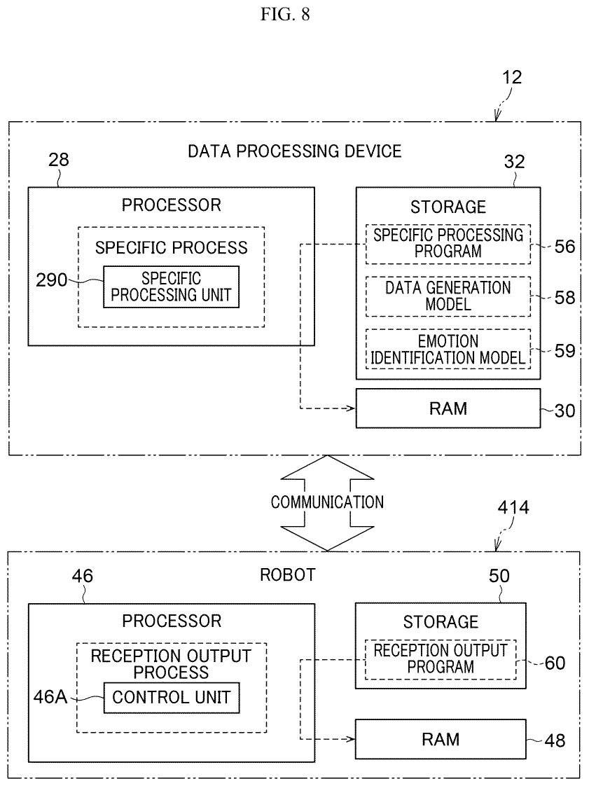

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

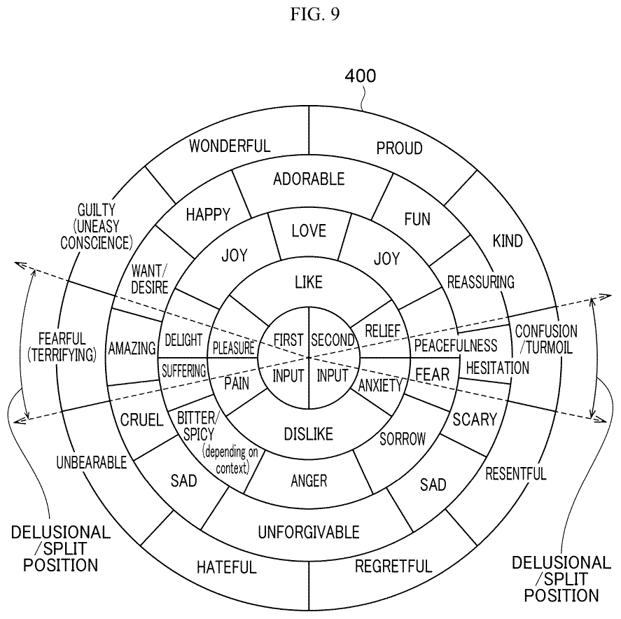

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

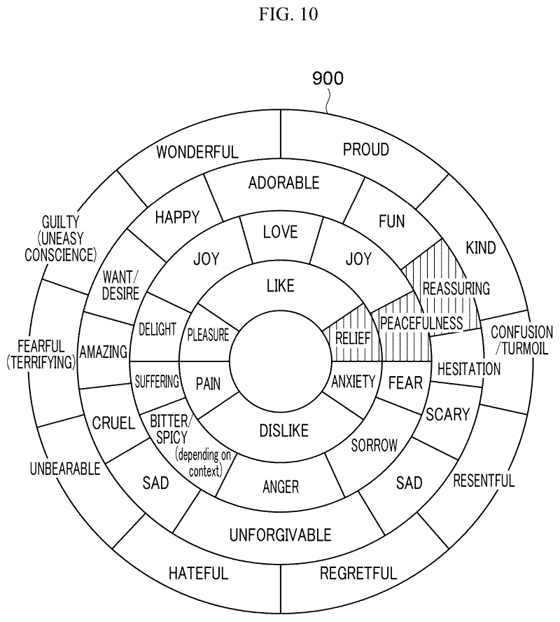

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
obtain monitoring information indicating an operating status of an information processing apparatus, perform threshold determination or pattern determination on the monitoring information to determine whether an anomaly is present, and, when the anomaly is detected, generate anomaly information including at least an error type, an occurrence time, and related data as structured data, and
generate a prompt sentence including the generated anomaly information and environment information associated with the anomaly information, the prompt sentence being configured to instruct a generative language processing model to perform analysis of anomaly content, estimation of a cause, and presentation of a countermeasure, and
input the generated prompt sentence into the generative language processing model, acquire a natural language output including at least anomaly content, a cause, and a countermeasure from the generative language processing model, and store or present the natural language output in association with the anomaly information, and
extract an operation procedure or a processing command included in the natural language output from the generative language processing model, and generate, on the basis of the operation procedure or the processing command, an automatic processing job or an operation procedure document.

### Supplementary 2

The system according to supplementary 1,
wherein the processor is configured to
generate the prompt sentence such that the prompt sentence includes an instruction to the generative language processing model to refer to at least one of a knowledge base storing past anomaly information and corresponding countermeasures and a similar-incident retrieval mechanism, and to cause the generative language processing model to perform cause identification and extraction of candidate countermeasures based on similarity to past cases.

### Supplementary 3

The system according to supplementary 1,
wherein the processor is configured to
store the generated anomaly information, an analysis result obtained by the generative language processing model, and the generated prompt sentence in association with one another, and, for a subsequently occurring anomaly, reuse at least one of the stored prompt sentence and the stored analysis result to automate or simplify generation of a new prompt sentence.

### Application Example 1

### Supplementary 1

A system comprising a processor,
wherein the processor is configured to
acquire operation history information of an information processing apparatus and generate structured abnormality information data based on the operation history information, determine, on the basis of the abnormality information data, whether an abnormality has occurred, and generate abnormality record data when the abnormality has occurred,
generate analysis data that includes a cause candidate of the abnormality and a countermeasure candidate of the abnormality based on the abnormality record data and past abnormality record data, and generate a prompt sentence including the analysis data,
input the prompt sentence to a generative information processing model and obtain text data including content of the abnormality and recommended response procedures from the generative information processing model,
generate notification data based on the text data and the abnormality record data and notify a communication apparatus of occurrence of the abnormality using the notification data, generate processing request data for a managed apparatus based on the notification data or an operation instruction from a user and execute control processing on the managed apparatus in response to the processing request data, and
store a result of the control processing and the text data as abnormality response history data and record the abnormality response history data as learning data that is reusable for generation of the analysis data and the prompt sentence.

### Supplementary 2

The system according to supplementary 1,
wherein the processor is configured to
generate the analysis data by calculating, by using a machine learning model, cause classification information of the abnormality and importance information of the abnormality based on feature quantities extracted from the abnormality record data and feature quantities relating to similar events acquired from the abnormality response history data, and generate the prompt sentence including the cause classification information and the importance information.

### Supplementary 3

The system according to supplementary 1,
wherein the processor is configured to
execute the control processing by extracting a plurality of countermeasure candidate procedures based on the text data obtained from the generative information processing model and the abnormality response history data, selecting a countermeasure procedure from among the countermeasure candidate procedures based on an evaluation index, generating a prompt sentence including the selected countermeasure procedure, inputting the prompt sentence to the generative information processing model to obtain concrete processing procedures for automatic execution, and controlling the managed apparatus according to the concrete processing procedures.

### Example 2

### Supplementary 1

A system comprising a processor,
wherein the processor is configured to
monitor an operating state of an information processing apparatus, periodically read log data including abnormal information from a storage unit, and acquire the abnormal information output from the information processing apparatus,
convert the acquired abnormal information into an analyzable format by performing character string analysis on unstructured text data including the abnormal information, extract time information, identification information, resource name information, and event content information from the unstructured text data, and store extraction results as structured data in the storage unit,
generate, on the basis of the structured data, a prompt sentence in a natural language that instructs a generative artificial intelligence model to identify a content of an abnormality, a cause of the abnormality, and an impact range of the abnormality, and to generate a countermeasure for the abnormality, and generate input data for the generative artificial intelligence model including the prompt sentence,
cause the generative artificial intelligence model to operate on the input data including the structured data and the prompt sentence, and acquire output data including an analysis result relating to the content of the abnormality, the cause of the abnormality, the impact range of the abnormality, and the countermeasure,
analyze the output data, extract information indicating the content of the abnormality, the cause of the abnormality, the impact range of the abnormality, and the countermeasure,
associate the information with the identification information, store the associated information in the storage unit, and convert the information into display data to be notified to an information terminal, and
transmit the display data to the information terminal via a communication network so that the information terminal displays the content of the abnormality, the cause of the abnormality, the impact range of the abnormality, and the countermeasure.

### Supplementary 2

The system according to supplementary1,
wherein the processor is configured to
generate the prompt sentence in the natural language such that, on the basis of the abnormal information and the structured data, past abnormal information and a solution corresponding to the past abnormal information, the past abnormal information and the solution being stored in a history storage unit, are referred to in order to identify the cause of the abnormality, and such that an additional prompt sentence is generated to instruct the generative artificial intelligence model to estimate the cause of the abnormality.

### Supplementary 3

The system according to supplementary 1,
wherein the processor is configured to
generate the prompt sentence in the natural language such that, when proposing the countermeasure for the abnormality, past abnormal information and a plurality of solutions corresponding to the past abnormal information, the past abnormal information and the plurality of solutions being stored in a history storage unit, are referred to, and such that the generative artificial intelligence model is instructed, by the prompt sentence, to select, from among the plurality of solutions, a solution having a high degree of suitability for the abnormal information.

### Application Example 2

### Supplementary 1

A system comprising a processor,
wherein the processor is configured to
monitor an operating state of an information processing apparatus, and generate anomaly information based on log information, performance indicator information, and detector information output from the information processing apparatus; and
preprocess the anomaly information, the log information, and the performance indicator information to convert the information into structured data, input the structured data into a discriminative learning model to specify an anomaly type, an impact range, and candidate causes, and generate a prompt sentence based on a specification result and the structured data, the prompt sentence including contents of the anomaly, the impact range, and the candidate causes, and defining an output style and a level of explanation detail; and
input the prompt sentence into a generative learning model, cause the generative learning model to generate, in a natural language, an explanation and a stepwise resolution procedure in accordance with the contents of the anomaly and the candidate causes, store a generation result in a storage device in association with the anomaly information and history information, and notify a terminal device of the generation result; and
estimate an emotional state of a user based on voice information, image information, or text information acquired from the terminal device or a voice input device, and include the emotional state in the prompt sentence so as to cause the generative learning model to adjust a writing style, the level of explanation detail, and proposal contents of the explanation in accordance with the emotional state of the user; and
acquire an execution result of the resolution procedure and evaluation information thereof input from the terminal device, store the evaluation information in association with the anomaly information, the prompt sentence, and the generation result, and update at least one of an operation of the discriminative learning model, an operation of the generative learning model, and a generation rule of the prompt sentence based on an accumulation result of the evaluation information.

### Supplementary 2

The system according to supplementary 1,
wherein the processor is configured to, in order to specify a cause of the anomaly based on contents of the anomaly information, refer to past anomaly information stored in the storage device, corresponding resolution procedures, and evaluation information, extract the candidate causes based on a similarity to the past anomaly information and the evaluation information, and generate the prompt sentence including the candidate causes and the similarity, the prompt sentence being input to the generative learning model.

### Supplementary 3

The system according to supplementary 1,
wherein the processor is configured to, when proposing the resolution procedure for the anomaly, refer to the past anomaly information stored in the storage device, a plurality of corresponding resolution procedures, and the evaluation information, select a resolution procedure with high effectiveness based on the evaluation information, and generate the prompt sentence including a selection result and the emotional state of the user, the prompt sentence being input to the generative learning model to cause the generative learning model to generate, in the natural language, an optimum resolution procedure in which the level of explanation detail and a presentation order are adjusted in accordance with the emotional state of the user.

What is claimed is:

1. A system comprising:
a communication interface connected to a packet-switched network; and
circuitry configured to:
acquire, via the communication interface, time-series monitoring data transmitted from an information processing apparatus, the time-series monitoring data indicating an operating status of the information processing apparatus;
perform at least one of a threshold comparison operation and a pattern evaluation operation on the time-series monitoring data to determine whether an anomaly condition exists;
upon determining that the anomaly condition exists, generate anomaly data comprising at least an error classification identifier, a timestamp, and context data associated with the anomaly condition, the anomaly data being organized as structured data in a data storage device;
retrieve environment data describing a hardware or software configuration associated with the anomaly condition and associate the environment data with the anomaly data;
construct, based on the anomaly data and the environment data, a prompt data structure conforming to a template stored in the data storage device, the prompt data structure comprising a token sequence configured to instruct a generative neural network model to produce an analysis of the anomaly condition;
transmit, via the communication interface, the prompt data structure to the generative neural network model;
receive, from the generative neural network model, output data comprising a natural-language description of the anomaly condition, an estimated cause, and at least one countermeasure; and
store, in the data storage device, the output data in association with the anomaly data and the prompt data structure for retrieval during processing of a subsequent anomaly condition.

2. The system according to claim 1, wherein the circuitry is further configured to:
parse the output data to identify an operation procedure segment and a processing command segment; and
generate, based on the operation procedure segment and the processing command segment, at least one of an automatic processing job definition and an operation procedure document.

3. The system according to claim 2, wherein the automatic processing job definition comprises an execution order, precondition data, and rollback procedure data for each processing command in the processing command segment.

4. The system according to claim 2, wherein the circuitry is further configured to:
transmit the operation procedure document to a terminal device via the communication interface; and
receive, from the terminal device, an approval signal indicating authorization to execute the automatic processing job definition on the information processing apparatus.

5. The system according to claim 1, wherein the circuitry is further configured to:
compute a feature vector representing the anomaly data by encoding at least text fields of the anomaly data using an embedding model;
perform a similarity search over stored feature vectors of past anomaly data using a distance metric; and
upon identifying a past anomaly data entry exceeding a similarity threshold, retrieve a stored prompt data structure or stored output data associated with the past anomaly data entry and incorporate at least a portion thereof into the prompt data structure for the subsequent anomaly condition.

6. The system according to claim 5, wherein the similarity search uses an approximate nearest neighbor index structure stored in the data storage device.

7. The system according to claim 5, wherein incorporating the at least a portion comprises replacing fields in the stored prompt data structure that differ between the past anomaly data entry and the anomaly data while retaining structure and phrasing of the stored prompt data structure.

8. The system according to claim 1, wherein the generative neural network model comprises a transformer architecture including an embedding layer, a plurality of self-attention layers, a plurality of feed-forward layers, and an output projection layer.

9. The system according to claim 8, wherein the circuitry is further configured to configure decoding parameters of the generative neural network model comprising a maximum token length, a temperature value, and a top-probability threshold.

10. The system according to claim 1, wherein the circuitry is further configured to:
input the time-series monitoring data and the anomaly data into a discriminative learning model to obtain cause classification information comprising a probability distribution over anomaly cause categories, and importance information comprising a severity score; and
include the cause classification information and the importance information in the prompt data structure.

11. The system according to claim 10, wherein the discriminative learning model comprises a text encoder configured to process tokenized log entries and a numerical feature encoder configured to process performance indicator vectors, outputs of the text encoder and the numerical feature encoder being concatenated into a joint feature vector input to at least one classifier layer.

12. The system according to claim 10, wherein the circuitry is further configured to:
acquire, from a terminal device via the communication interface, evaluation information indicating effectiveness of the at least one countermeasure after execution; and
update at least one of parameters of the discriminative learning model and a generation rule of the prompt data structure based on an accumulation of the evaluation information.

13. The system according to claim 1, wherein the circuitry is further configured to:
convert unstructured text data comprising log entries from the information processing apparatus into the structured data by performing character string analysis to extract time information, identification information, resource name information, and event content information from the unstructured text data.

14. The system according to claim 1, wherein the circuitry is further configured to:
estimate an emotional state of a user based on at least one of voice information, image information, and text information acquired via the communication interface; and
include the emotional state in the prompt data structure to cause the generative neural network model to adjust at least one of a writing style, a level of explanation detail, and content of the at least one countermeasure.

15. The system according to claim 14, wherein the emotional state is estimated using an emotion identification model that maps input data to emotion values on an emotion map in which a plurality of emotions are arranged based on a structure giving rise to the emotions.

16. The system according to claim 1, wherein the circuitry is further configured to:
generate notification data comprising at least an anomaly identifier, the error classification identifier, and a severity indicator;
transmit the notification data to a terminal device via the communication interface over the packet-switched network; and
generate, in response to an operation instruction received from the terminal device, processing request data for a managed apparatus, the processing request data specifying a target resource identifier, an operation type, and execution parameters.

17. The system according to claim 16, wherein the circuitry is further configured to:
execute control processing on the managed apparatus in response to the processing request data; and
store a result of the control processing together with the output data as response history data, the response history data being reusable as learning data for generation of subsequent prompt data structures.

18. A system comprising:
a communication interface connected to a packet-switched network;
a data storage device; and
circuitry configured to:
acquire, via the communication interface, monitoring data from an information processing apparatus;
detect an anomaly condition in the monitoring data;
generate, upon detection of the anomaly condition, anomaly data comprising at least an error classification identifier, a timestamp, and context data, the anomaly data being stored in the data storage device;
retrieve, from the data storage device, past anomaly data and associated past output data;
construct a prompt data structure based on the anomaly data, environment data, and the past anomaly data;
transmit the prompt data structure to a generative neural network model and receive output data comprising an analysis and at least one countermeasure;
parse the output data to extract an operation procedure and a processing command;
generate at least one of an automatic processing job definition and an operation procedure document based on the operation procedure and the processing command; and
store the output data and the prompt data structure in association with the anomaly data in the data storage device.

19. A method comprising:
acquiring, by circuitry via a communication interface connected to a packet-switched network, time-series monitoring data transmitted from an information processing apparatus, the time-series monitoring data indicating an operating status of the information processing apparatus;
performing, by the circuitry, at least one of a threshold comparison operation and a pattern evaluation operation on the time-series monitoring data to determine whether an anomaly condition exists;
upon determining that the anomaly condition exists, generating, by the circuitry, anomaly data comprising at least an error classification identifier, a timestamp, and context data associated with the anomaly condition;
constructing, by the circuitry, based on the anomaly data and environment data describing a hardware or software configuration, a prompt data structure conforming to a template stored in a data storage device;
transmitting, by the circuitry via the communication interface, the prompt data structure to a generative neural network model;
receiving, by the circuitry from the generative neural network model, output data comprising a natural-language description of the anomaly condition, an estimated cause, and at least one countermeasure; and
storing, by the circuitry in the data storage device, the output data in association with the anomaly data and the prompt data structure for retrieval during processing of a subsequent anomaly condition.
